(19) United States
(12) Patent Application Publication
(10) Pub. No.: US 2013/0311175 A1
(43) Pub. Date: Nov. 21, 2013

(54) SPEECH PROCESSING APPARATUS, CONTROL METHOD THEREOF, STORAGE MEDIUM STORING CONTROL PROGRAM THEREOF, AND VEHICLE, INFORMATION PROCESSING APPARATUS, AND INFORMATION PROCESSING SYSTEM INCLUDING THE SPEECH PROCESSING APPARATUS

(71) Applicants: Takayuki Arakawa, Tokyo (JP); Akihiko Sugiyama, Tokyo (JP)

(72) Inventors: Takayuki Arakawa, Tokyo (JP); Akihiko Sugiyama, Tokyo (JP)

(73) Assignee: NEC CORPORATION, Tokyo (JP)

(21) Appl. No.: 13/978,671

(22) PCT Filed: Dec. 3, 2011
(86) PCT No.: PCT/JP2011/077995

§ 371 Date: Jul. 8, 2013

(30) Foreign Application Priority Data
Jan. 13, 2011 (JP) 2011-005315

(51) Int. Cl. G10L 21/0216

(52) U.S. Cl. CPC G10L 21/0216
USPC 704/226

(57) ABSTRACT

An apparatus of this invention is a speech processing apparatus that acquires pseudo speech from a mixture sound including desired speech and noise. The speech processing apparatus includes a first microphone that inputs a first mixture sound including desired speech and noise and outputs a first mixture signal, a second microphone that is opened to the same sound space as that of the first microphone, inputs a second mixture sound including the desired speech and the noise at a ratio different from the first mixture sound, and outputs a second mixture signal, a sound insulator that is disposed between the first microphone and the second microphone, and a noise suppression circuit that suppresses an estimated noise signal based on the first mixture signal and the second mixture signal and outputs a pseudo speech signal. With this arrangement, it is possible to, in a single sound space where desired speech and noise mix, correctly estimate the noise and reconstruct pseudo speech close to the desired speech.

### TECHNICAL FIELD

The present invention relates to a technique of acquiring pseudo speech from a mixture sound including desired speech and noise.

### BACKGROUND ART

In the above-described technical field, patent literature 1 discloses a technique of suppressing, in a vehicle, noise that has come from outside the car and mixed with speech in the car. In patent literature 1, the outside-car noise is suppressed using an adaptive filter based on the output signal of a microphone that picks up the in-car speech and the output signal of a microphone that picks up the outside-car noise.

### CITATION LIST

### Patent Literature

Patent literature 1: Japanese Patent Laid-Open No. 2-246599

### SUMMARY OF THE INVENTION

### Technical Problem

However, the technique of patent literature 1 aims at suppressing noise in a sound space (in this case, outside the car) different from a sound space where the desired speech exists. It is therefore impossible to suppress noise generated in the sound space where the desired speech exists. For example, it is impossible to effectively suppress in-car noise (noise whose generation source is located in the car) from a mixture signal including in-car speech and the in-car noise.

The present invention enables to provide a technique of solving the above-described problem.

### Solution to Problem

One aspect of the present invention provides a speech processing apparatus comprising:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a sound insulator that is disposed between the first microphone and the second microphone; and
a noise suppression circuit that suppresses an estimated noise signal based on the first mixture signal and the second mixture signal and outputs a pseudo speech signal.

Another aspect of the present invention provides a vehicle including the speech processing apparatus,
wherein the first microphone is disposed at a position where the sound insulator does not shield desired speech uttered by an occupant but shields noise generated from a noise source, and
the second microphone is disposed at a position where the sound insulator shields the desired speech uttered by the occupant but does not shield the noise generated from the noise source.

Still other aspect of the present invention provides an information processing apparatus including the speech processing apparatus,
wherein the first microphone is disposed at a position where the sound insulator does not shield desired speech uttered by an operator of the information processing apparatus but shields noise generated from a noise source, and
the second microphone is disposed at a position where the sound insulator shields the desired speech uttered by the operator but does not shield the noise generated from the noise source.

Still other aspect of the present invention provides an information processing system including the speech processing apparatus, comprising:
a speech recognition apparatus that recognizes desired speech from the pseudo speech signal output from the speech processing apparatus; and
an information processing apparatus that processes information in accordance with the desired speech recognized by the speech recognition apparatus.

Still other aspect of the present invention provides a control method of a speech processing apparatus including:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a sound insulator that is disposed between the first microphone and the second microphone; and
a noise suppression circuit that suppresses an estimated noise signal based on the first mixture signal and the second mixture signal and outputs a pseudo speech signal, the method comprising:
acquiring a parameter of the noise suppression circuit;
determining, in accordance with the parameter of the noise suppression circuit, at least one of a position of the sound insulator and a direction of the first microphone to shield the noise and cause the first microphone to collect the desired speech; and
controlling at least one of the position of the sound insulator and the direction of the first microphone.

Still other aspect of the present invention provides a non-transitory computer-readable storage medium storing a control program of a speech processing apparatus including:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a sound insulator that is disposed between the first microphone and the second microphone; and
a noise suppression circuit that suppresses an estimated noise signal based on the first mixture signal and the second mixture signal and outputs a pseudo speech signal, the control program causing a computer to execute:
acquiring a parameter of the noise suppression circuit;
determining, in accordance with the parameter of the noise suppression circuit, at least one of a position of the sound insulator and a direction of the first microphone to shield the noise and cause the first microphone to collect the desired speech; and
controlling at least one of the position of the sound insulator and the direction of the first microphone.

### Advantageous Effects of Invention

According to the present invention, it is possible to, in a single sound space where desired speech and noise mix, correctly estimate the noise and reconstruct pseudo speech close to the desired speech.

### BRIEF DESCRIPTION OF THE DRAWINGS

FIG. 1 is a block diagram showing the arrangement of a speech processing apparatus according to the first embodiment of the present invention;

FIG. 2 is a block diagram showing the arrangement of a speech processing system including a speech processing apparatus according to the second embodiment of the present invention;

FIG. 3 is a view showing the arrangement of a noise suppression circuit according to the second embodiment of the present invention;

FIG. 4A is a block diagram showing the hardware arrangement of the speech processing apparatus according to the second embodiment of the present invention;

FIG. 4B is a view showing the arrangement of a sound insulator/microphone position control parameter DB according to the second embodiment of the present invention;

FIG. 5 is a view showing the state of sound insulator position change according to the second embodiment of the present invention;

FIG. 6 is a flowchart showing the processing procedure of instructing sound insulator position change according to the second embodiment of the present invention;

FIG. 7 is a view showing the state of sound insulator position control according to the second embodiment of the present invention;

FIG. 8 is a flowchart showing the processing procedure of sound insulator position control according to the second embodiment of the present invention;

FIG. 9 is a view showing the state of first microphone position control according to the second embodiment of the present invention;

FIG. 10 is a flowchart showing the processing procedure of first microphone position control according to the second embodiment of the present invention;

FIG. 11 is a view showing other examples of the sound insulator of the speech processing apparatus according to the second embodiment of the present invention;

FIG. 12 is a block diagram showing the arrangement of a speech processing system including a speech processing apparatus according to the third embodiment of the present invention;

FIG. 13 is a block diagram showing the arrangement of a speech processing system including a speech processing apparatus according to the fourth embodiment of the present invention;

FIG. 14 is a flowchart showing the processing procedure of first microphone position control according to the fourth embodiment of the present invention;

FIG. 15 is a block diagram showing the arrangement of a speech processing system including a speech processing apparatus according to the fifth embodiment of the present invention;

FIG. 16 is a view showing other layouts of a first microphone according to the fifth embodiment of the present invention;

FIG. 17 is a block diagram showing another arrangement of the speech processing system including the speech processing apparatus according to the fifth embodiment of the present invention;

FIG. 18 is a view showing still other layouts of the first microphone according to the fifth embodiment of the present invention;

FIG. 19 is a block diagram showing the hardware arrangement of the speech processing apparatus according to the fifth embodiment of the present invention;

FIG. 20 is a view showing the arrangement of a microphone position control table according to the fifth embodiment of the present invention;

FIG. 21 is a view showing the state of first microphone position control according to the fifth embodiment of the present invention; and

FIG. 22 is a flowchart showing the processing procedure of first microphone position control according to the fifth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

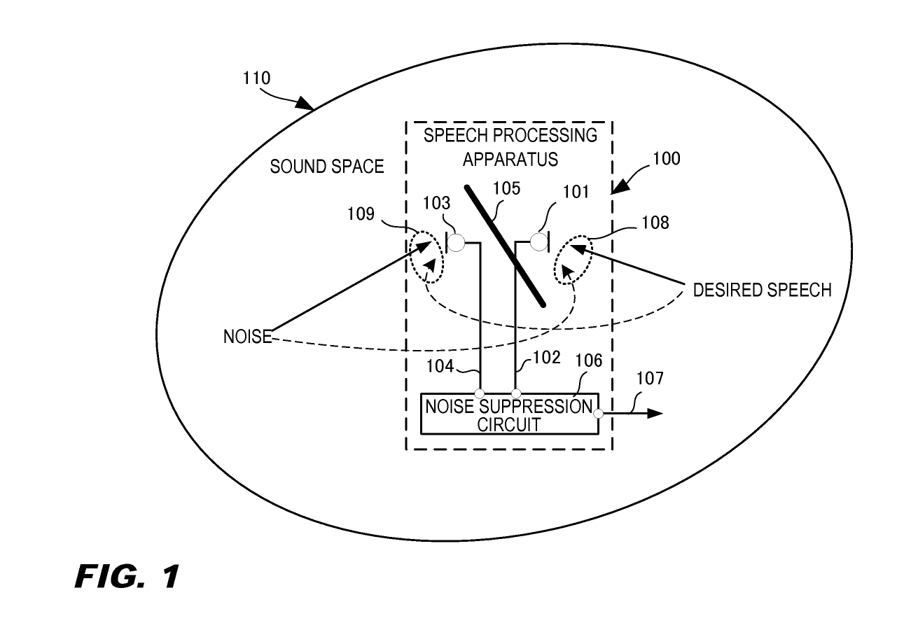

A speech processing apparatus 100 according to the first embodiment of the present invention will be described with reference to FIG. 1. As shown in FIG. 1, the speech processing apparatus 100 includes a first microphone 101, a second microphone 103, a sound insulator 105, and a noise suppression circuit 106. The first microphone 101 inputs a first mixture sound 108 including desired speech and noise, and outputs a first mixture signal 102 including a desired speech signal and a noise signal. The second microphone 103 is opened to a sound space 110 that is the same as the sound space of the first microphone 101. The second microphone 103 inputs a second mixture sound 109 including the desired speech and the noise at a ratio different from the first mixture sound 108, and outputs a second mixture signal 104 including the desired speech signal and the noise signal at a ratio different from the first mixture signal 102. The sound insulator 105 is disposed between the first microphone 101 and the second microphone 103. The noise suppression circuit 106 suppresses an estimated noise signal based on the first mixture signal 102 and the second mixture signal 104, and outputs an estimated desired speech signal 107.

According to this embodiment, it is possible to, in a single sound space where desired speech and noise mix, correctly estimate the noise and reconstruct pseudo speech close to the desired speech.

### Second Embodiment

In the second embodiment, a speech processing system that applies a speech processing apparatus of the present invention to a vehicle will be described. In the second embodiment, first and second microphones and a sound insulator are attached to a sun visor in a vehicle. Alternatively, the sound insulator may serve as the sun visor. According to this embodiment, it is possible to correctly suppress in-car noise in the sound space in a vehicle where in-car speech and the in-car noise mix.

<Arrangement of Speech Processing System Including Speech Processing Apparatus According to This Embodiment>

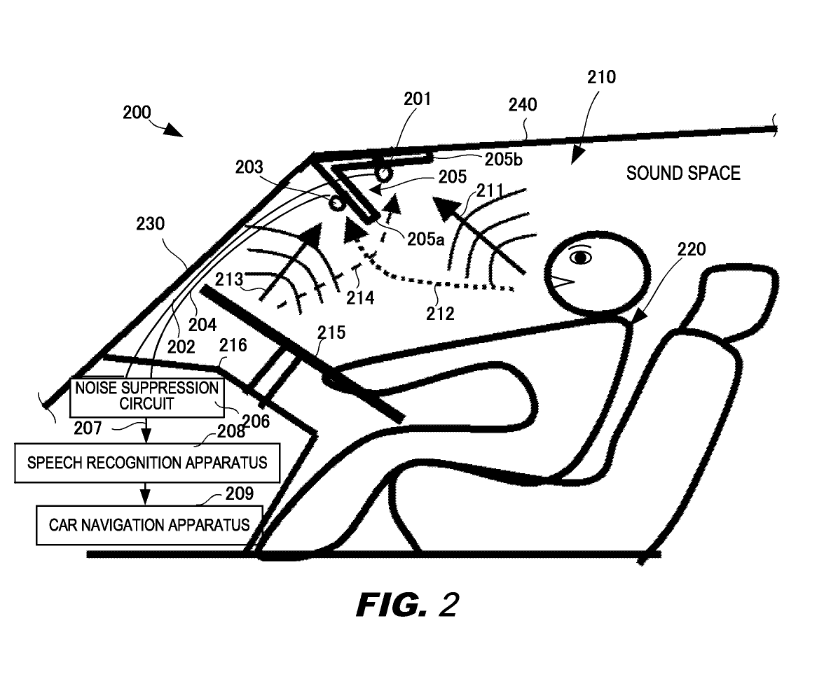

FIG. 2 is a block diagram showing the arrangement of a speech processing system 200 including a speech processing apparatus according to this embodiment. Note that referring to FIG. 2, the speech processing apparatus includes a first microphone 201, a second microphone 203, a sound insulator 205, and a noise suppression circuit 206. The speech processing system 200 includes the speech processing apparatus, and additionally, a speech recognition apparatus 208 and and a car navigation apparatus 209. Note that the first microphone 201, the second microphone 203, and the sound insulator 205 may be provided as an integrated speech input unit.

Referring to FIG. 2, a sound space 210 is the space in a vehicle. The sound space 210 shown in FIG. 2 is partially delimited by a windshield 230 and a ceiling 240. The arrangement and operation of the second embodiment will be described below by exemplifying a case in which an occupant 220 manipulates the car navigation apparatus 209 by speech in the sound space 210 where noise from an air conditioner or the like mixes. Note that the air conditioner is assumed to exist in a dashboard 216. However, the noise source is not limited to the air conditioner and may be another device disposed at another position. The speech of the occupant 220 need not always be used to manipulate the car navigation apparatus 209.

In the speech processing apparatus according to this embodiment, the first microphone 201, the second microphone 203, and the sound insulator 205 are disposed at the ceiling portion on the front side of the car. The sound insulator 205 includes a first sound insulating portion 205a that projects at an acute angle from the ceiling 240 into the car and crosses a line segment connecting the first microphone 201 and the noise source, and a second sound insulating portion 205b attached to the ceiling 240. The end face of the first sound insulating portion 205a and the second sound insulating portion 205b cut along a plane formed by a line connecting the first microphone 201 and the speech source and a line connecting the first microphone 201 and the noise source has a “V shape” or an “L shape”. That is, the first sound insulating portion 205a and the second sound insulating portion 205b are disposed such that when the sound insulator is cut along a plane perpendicular to the line connecting the first microphone 201 and the speech source, the sectional area remains the same or becomes small from the speech source to the first microphone 201. However, the angle of the first sound insulating portion 205a and the second sound insulating portion 205b is not limited to the acute angle, and an appropriate angle is selected in accordance with the structure in the vehicle, the vehicle height, the seat position, the height of the occupant, the position of the noise source, and the like. Note that the first sound insulating portion 205a may be attached to the sun visor. The sun visor may be made using a material serving as a sound insulator. In this case, it is particularly preferable to make the sun visor using a material that is transparent without direct sunlight, but upon receiving direct sunlight, becomes opaque and thus shields the sunlight.

In FIG. 2, the first microphone 201 is attached to the second sound insulating portion 205b of the sound insulator 205 on, for example, the interior angle side of the “L-shaped end face” in a direction to input speech uttered by the occupant 220. The second sound insulating portion 205b of the sound insulator can shield solid borne noise (not shown) transmitted from the air conditioner or the like to the first microphone 201 through the windshield 230 and the ceiling 240. On the other hand, the second microphone 203 is attached to the opposite surface of the first sound insulating portion 205a of the sound insulator 205 from the first microphone 201 on, for example, the exterior angle side of the “L-shaped end face” in a direction to input noise generated by the air conditioner inside the dashboard 216. The first sound insulating portion 205a of the sound insulator 205 shields input of airborne noise 213 from the air conditioner or the like to the first microphone 201. At the same time, the first sound insulating portion 205a of the sound insulator 205 shields input of airborne speech 211 uttered by the occupant 220 to the second microphone 203. For this reason, the airborne speech 211 uttered by the occupant 220 is mainly input to the first microphone 201, and the airborne noise 213 generated by the air conditioner is mainly input to the second microphone 203. However, since the sound insulator 205 does not form a closed space, airborne noise 214 getting around the first sound insulating portion 205a mixes into the first microphone 201. In addition, airborne speech 212 getting around the first sound insulating portion 205a mixes into the second microphone 203.

The first microphone 201 converts a first mixture sound including the input airborne speech 211 and the airborne noise 214 that has got around into a first mixture signal 202 including a speech signal and a noise signal and transmits it to the noise suppression circuit 206. On the other hand, the second microphone 203 receives a second mixture sound including the airborne noise 213 and the airborne speech 212 that has got around at a ratio different from the first mixture sound. The second microphone 203 converts the second mixture sound into a second mixture signal 204 including a speech signal and a noise signal at a ratio different from the first mixture signal and transmits it to the noise suppression circuit 206.

The noise suppression circuit 206 outputs a pseudo speech signal 207 based on the transmitted first mixture signal 202 and second mixture signal 204. The pseudo speech signal 207 is recognized by the speech recognition apparatus 208 and processed by the car navigation apparatus 209 as a manipulation by the speech of the occupant 220.

In the above-described way, in the sound space 210 of the vehicle where the desired speech and the in-car noise mix, speech uttered by the occupant 220 and indicating a manipulation of the car navigation apparatus 209 is input to the first microphone 201 and the second microphone 203 as mixture sounds of different mixture ratios. The noise suppression circuit 206 reconstructs the pseudo speech signal based on the first mixture signal from the first microphone 201 and the second mixture signal from the second microphone 203. The speech recognition apparatus 208 recognizes the reconstructed pseudo speech signal. The car navigation apparatus 209 is manipulated by the recognized speech.

Note that the signal lines that transmit the first mixture signal 202 and the second mixture signal 204 may transmit the return signal of a ground power supply or the like or a power supply for operating the microphone. The noise suppression circuit 206 may be attached to the sound insulator 205. In this case, the pseudo speech signal is transmitted from the noise suppression circuit 206 to the speech recognition apparatus 208 through a signal line. In this embodiment, speech recognition and car navigation will be explained. However, the present invention is not limited to this, and correct reconstruction of the speech uttered by the occupant 220 is useful in another processing as well. For example, application to an automobile telephone or application to a vehicle manipulation that is not directly associated with driving is also possible.

(Structure of Sound Insulator)

The sound insulator preferably uses a substance having a large mass and a high density. Such a substance needs a larger energy to oscillate and can therefore prevent a sound from passing through. The sound insulator preferably uses a hard material for the surface and a soft material for the interior. A hard material easily reflects a sound. For this reason, when a hard material is used for the surface of the sound insulator, a sound reflected by the sound insulator can also be collected in addition to a sound directly input to the microphone. A soft material easily absorbs a sound. For this reason, when a soft material is used for the interior of the sound insulator, unnecessary sound penetration can be prevented. The surface part on the first microphone side and the surface part on the second microphone side are preferably not continuous but separated. In a continuous structure, a sound propagates through the surface part and passes through the sound insulator. To prevent this, the sound insulator preferably has a three-layer structure in which a part made of a soft material is sandwiched between two surface parts made of a hard material.

<Arrangement of Noise Suppression Circuit>

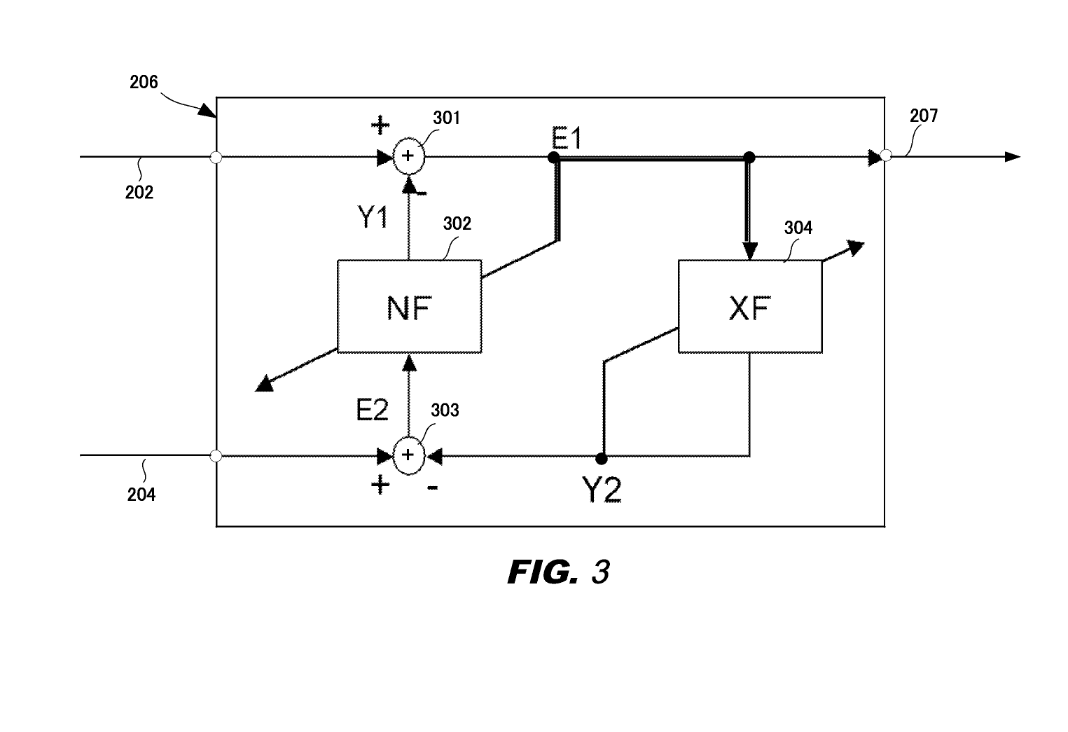

FIG. 3 is a view showing the arrangement of the noise suppression circuit 206 according to this embodiment.

The noise suppression circuit 206 includes a subtracter 301 that subtracts, from the first mixture signal 202, an estimated noise signal Y1 estimated to be included in the first mixture signal 202. The noise suppression circuit 206 also includes a subtracter 303 that subtracts, from the second mixture signal 204, an estimated speech signal Y2 estimated to be included in the second mixture signal 204. The noise suppression circuit 206 also includes an adaptive filter NF 302 serving as an estimated noise signal generator that generates the estimated noise signal Y1 from a pseudo noise signal E2 output from the subtracter 303. The noise suppression circuit 206 also includes an adaptive filter XF 304 serving as an estimated speech signal generator that generates the estimated speech signal Y2 from a pseudo speech signal E1 (207) output from the subtracter 303. A detailed example of the adaptive filter XF 304 is described in International Publication No. 2005/024787. Even when the target speech gets around and is input to the second microphone 203, and the second mixture signal 204 includes the speech signal, the adaptive filter XF 304 can prevent the subtracter 301 from erroneously removing the speech signal of the speech that has got around from the first mixture signal 202.

With this arrangement, the subtracter 301 subtracts the estimated noise signal Y1 from the first mixture signal 202 transmitted from the first microphone 201 and outputs the pseudo speech signal E1 (207).

The estimated noise signal Y1 is generated from the pseudo noise signal E2 by the adaptive filter NF 302 using a parameter that changes based on the pseudo speech signal E1 (207). The pseudo noise signal E2 is obtained by causing the subtracter 303 to subtract the estimated speech signal Y2 from the second mixture signal 204 transmitted from the second microphone 203 through a signal line.

The estimated speech signal Y2 is generated from the pseudo speech signal E1 (207) by the adaptive filter XF 304 using a parameter that changes based on the estimated speech signal Y2.

Note that the noise suppression circuit 206 can be an analog circuit, a digital circuit, or a circuit including both. When the noise suppression circuit 206 is an analog circuit, and the pseudo speech signal E1 (207) is used for digital control, an A/D converter converts the signal into a digital signal. On the other hand, when the noise suppression circuit 206 is a digital circuit, the signal from the microphone is converted into a digital signal by an A/D converter before input to the noise suppression circuit 206. If both an analog circuit and a digital circuit are included, for example, the subtracter 301 or 303 may be formed from an analog circuit, and the adaptive filter NF 302 or the adaptive filter XF 304 is formed from an analog circuit controlled by a digital circuit. The noise suppression circuit 206 shown in FIG. 3 is one of examples of the circuit suitable for this embodiment. An existing circuit that subtracts the estimated noise signal from the first mixture signal and outputs the pseudo speech signal is usable. The characteristic structure of this embodiment including the two microphones and the sound insulator enables to suppress noise. For example, the adaptive filter XF 304 shown in FIG. 3 may be replaced with a circuit that outputs a predetermined level to filter diffused speech. The subtracter 301 and/or the subtracter 303 may be replaced with an integrator by expressing a coefficient for integrating the estimated noise signal Y1 or the estimated speech signal Y2 with the first mixture signal 202 or the second mixture signal 204.

<Hardware Arrangement of Speech Processing Apparatus>

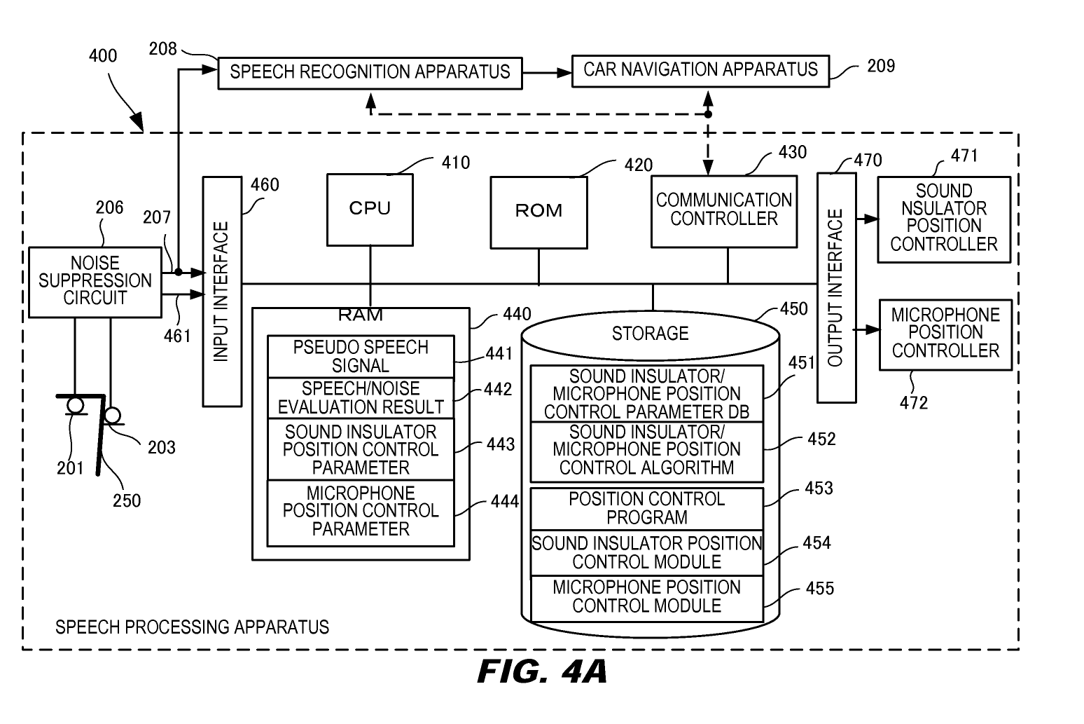

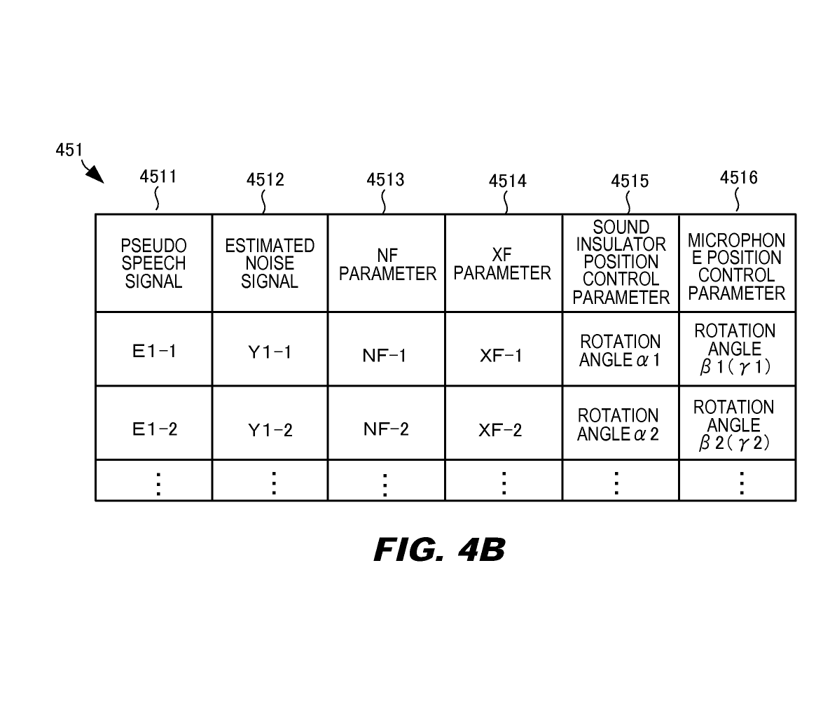

FIG. 4A is a block diagram showing the hardware arrangement of a speech processing apparatus 400 according to this embodiment. Note that FIG. 4A illustrates the speech recognition apparatus 208 and the car navigation apparatus 209 connected to the speech processing apparatus 400.

Referring to FIG. 4A, a CPU 410 is a processor for arithmetic control and implements the controller of the speech processing apparatus 400 by executing a program. A ROM 420 stores initial data, permanent data of programs and the like, and the programs. A communication controller 430 exchanges information between the speech processing apparatus 400, the speech recognition apparatus 208, and the car navigation apparatus 209. The communication can be either wired or wireless. Note that FIG. 4A illustrates the noise suppression circuit 206 as a unique functional component. However, processing of the noise suppression circuit 206 may be implemented partially or wholly by processing of the CPU 410.

A RAM 440 is a random access memory used by the CPU 410 as a work area for temporary storage. Areas to store data necessary for implementing the embodiment are allocated in the RAM 440. The areas store digital data 441 of the pseudo speech signal 207 output from the noise suppression circuit 206 and an evaluation result 442 obtained by evaluating the speech input to the microphone based on the strength of the speech signal, the ratio of the speech and noise, and the like. The RAM 440 also stores a sound insulator position control parameter 443 determined from the evaluation result 442, and a microphone position control parameter 444 determined from the evaluation result 442.

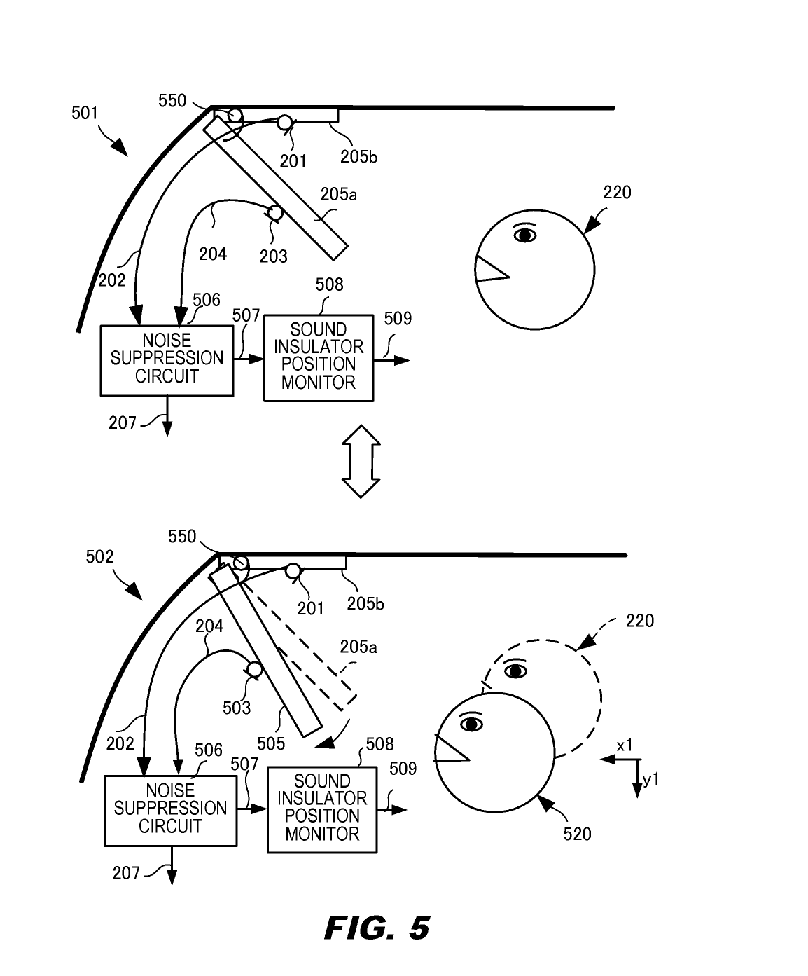

A storage 450 is a mass storage device that nonvolatilely stores databases, various kinds of parameters, and programs to be executed by the CPU 410. The storage 450 stores the following data and programs necessary for implementing the embodiment. As a data storage, the storage 450 stores a sound insulator/microphone position control parameter DB 451 used to determine the sound insulator position control parameter 443 or the microphone position control parameter 444 from the evaluation result 442 (see FIG. 5). The storage 450 also stores a sound insulator/microphone position control algorithm 452 such as an arithmetic expression used to determine the sound insulator position control parameter 443 or the microphone position control parameter 444 from the evaluation result 442 as needed without using the sound insulator/microphone position control parameter DB 451. In this embodiment, the storage 450 stores, as a program, a position control program 453 used to control the sound insulator position or the microphone position. The storage 450 also stores a sound insulator position control module 454 that controls the sound insulator position and a microphone position control module 455 that controls the microphone position. Note that one or both of the sound insulator position control and the microphone position control can be performed. If the sound insulator/microphone position control is not automatically performed, the evaluation result 442 can also be displayed on the display of the car navigation apparatus 209 via the communication controller 430 so as to instruct the occupant 220 to adjust the sound insulator/microphone position.

An input interface 460 inputs control signals and data necessary for control by the CPU 410. In this embodiment, the input interface 460 inputs the pseudo speech signal 207 output from the noise suppression circuit 206 and a parameter of the adaptive filter NF 302 or the adaptive filter XF 304 or a parameter 461 of the estimated noise signal Y1 or the like. The parameter 461 is used to control the position of the sound insulator or the microphone. An output interface 470 outputs control signals and data to a device under the control of the CPU 410. In this embodiment, the output interface 470 outputs the sound insulator position control parameter 443 to a sound insulator position controller 471 or outputs the microphone position control parameter 444 to a microphone position controller 472. If the sound insulator position controller 471 or the microphone position controller 472 includes a motor, the sound insulator position control parameter 443 or the microphone position control parameter 444 includes a rotation direction and a rotation angle.

Note that FIG. 4A illustrates only the data and programs indispensable in this embodiment but not general-purpose data and programs such as the OS. The CPU 410 in FIG. 4A may also perform another vehicle control. As described above, the noise suppression circuit 206 can be either an analog circuit or a digital circuit. For example, when the noise suppression circuit 206 is a digital circuit, the CPU 410 shown in FIG. 4A can implement the noise suppression circuit 206 in accordance with a program.

(Arrangement of Sound Insulator/Microphone Position Control Parameter DB)

FIG. 4B is a view showing the arrangement of the sound insulator/microphone position control parameter DB 451 according to this embodiment.

The sound insulator/microphone position control parameter DB 451 includes, as a condition, at least one of a pseudo speech signal 4511, an estimated noise signal 4512, a parameter 4513 of the adaptive filter NF, and a parameter 4514 of the adaptive filter XF acquired from the noise suppression circuit 206. A sound insulator position control parameter 4515 and a microphone position control parameter 4516 are stored in association with the condition.

<Processing Procedure of Speech Processing Apparatus According to This Embodiment>

(Sound Insulator Position Change)

FIG. 5 is a view showing the state of sound insulator position change according to this embodiment. In FIG. 5, a position change mechanism 550 is attached to change the position of the first sound insulating portion 205a. The apparatus is configured to notify the occupant that the layout of the first microphone 201, the second microphone 203, and the sound insulator 205 is not appropriate. Referring to FIG. 5, the speech processing apparatus includes a sound insulator position monitor 508 to notify the occupant 220 of the sound insulator position change. A noise suppression circuit 506 has the same arrangement as that of the above-described noise suppression circuit 206 and outputs a parameter 507 for position monitoring to the sound insulator position monitor 508.

An upper column 501 of FIG. 5 indicates a state in which the position of the first sound insulating portion 205a of the sound insulator is appropriate, and a correct pseudo speech signal is output by suppressing the noise signal. An output signal 509 from the sound insulator position monitor 508 represents that the sound insulator position is appropriate. For example, the car navigation apparatus 209 notifies by the output signal 509 from the sound insulator position monitor 508 that the sound insulator position is appropriate.

A lower column 502 of FIG. 5 indicates a case in which the occupant 220 has moved downward (y1) or forward (x1) (indicated by 520). In this case, if the first sound insulating portion 205a of the sound insulator is located at the position in the upper column 501, part of the speech uttered by the occupant 520 is shielded by the first sound insulating portion 205a of the sound insulator and does not propagate to the first microphone 201. On the other hand, part of the speech uttered by the occupant 520 is not shielded by the first sound insulating portion 205a of the sound insulator and propagates to the second microphone 203. This state is sensed by the sound insulator position monitor 508 and notified to the occupant 520 by, for example, the car navigation apparatus 209 based on the output signal 509. The occupant 520 confirms the notification and moves the first sound insulating portion 205a of the sound insulator to a position 505, as in the lower column 502. The occupant 220 thus moves the sound insulator up to an appropriate position.

Note that if the occupant 220 has moved upward or backward, the sound insulator does not inappropriately shield the mixture sounds input to the microphones. However, when the first sound insulating portion of the sound insulator moves downward, the amount of noise mixing into the first microphone 201 increases. Hence, a notification may be done to cause the occupant 220 to return the first sound insulating portion of the sound insulator to the position in the upper column 501 of FIG. 5 or move the first sound insulating portion upward.

(Processing Procedure of Instructing Sound Insulator Position Change)

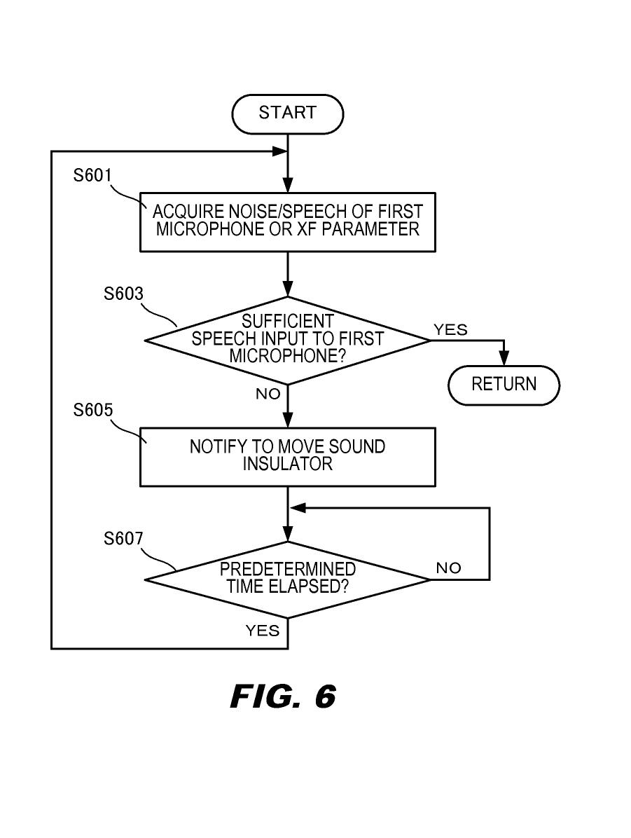

FIG. 6 is a flowchart showing the processing procedure of instructing sound insulator position change according to this embodiment. The CPU 410 shown in FIG. 4A executes the flowchart of FIG. 6 using the RAM 440, thereby implementing the sound insulator position monitor 508 shown in FIG. 5.

In step S601, the ratio of noise and speech in the first microphone 201, the parameter of the adaptive filter XF of the circuit shown in FIG. 3, and the like are acquired from the noise suppression circuit 506. In step S603, it is judged whether the speech input to the first microphone 201 is sufficient. If the speech input to the first microphone 201 is sufficient, the processing ends.

On the other hand, if the speech input to the first microphone 201 is not sufficient, the occupant 220 is notified to move the sound insulator 205 in step S605. In step S607, the process waits for the time of adjustment of the sound insulator 205 by the occupant 220. Then, the process returns to step S601 to repeat the processing until the speech is sufficiently input to the first microphone 201.

(Sound Insulator Position Control)

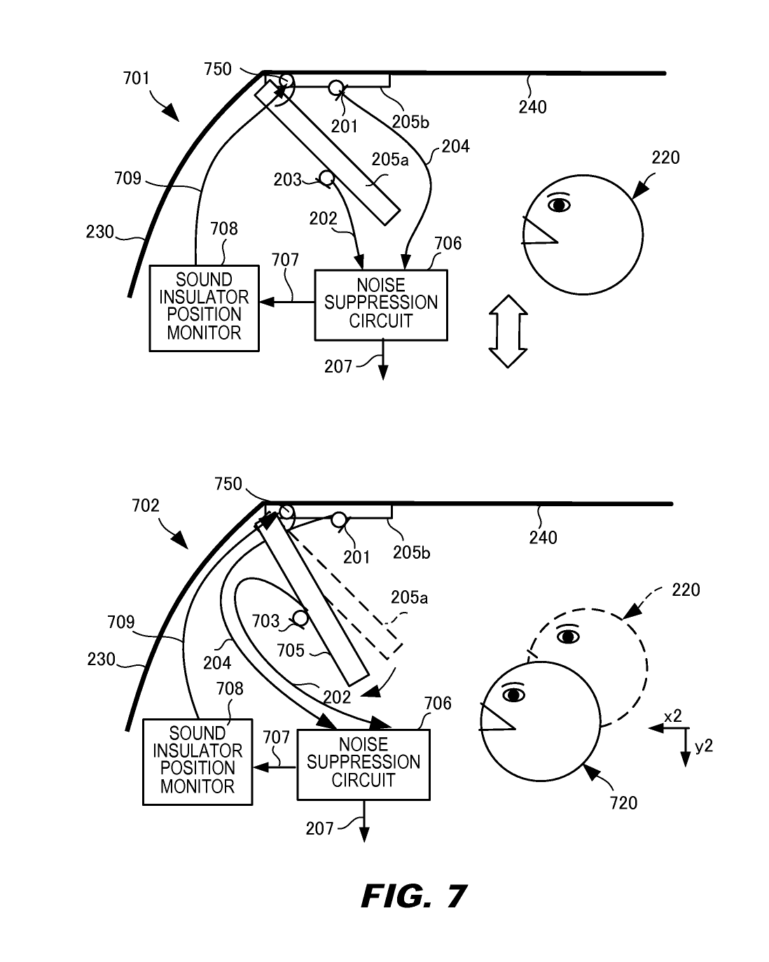

FIG. 7 is a view showing the state of sound insulator position control according to this embodiment. In FIG. 7, the apparatus is configured to perform automatic adjustment upon judging that the layout of the first microphone 201, the second microphone 203, and the sound insulator 205 is not appropriate. Referring to FIG. 7, a sound insulator position controller 708 that controls the sound insulator position and a position change mechanism 750 serving as a sound insulator moving unit capable of moving the position of the first sound insulating portion 205a of the sound insulator in accordance with a control signal 709 from the sound insulator position controller 708 are added. The position change mechanism 750 can include a moving motor. The apparatus includes a signal line that transmits the control signal 709 of the sound insulator position controller 708 to the position change mechanism 750. A noise suppression circuit 706 has the same arrangement as that of the above-described noise suppression circuit 206 and outputs a parameter 707 for position control to the sound insulator position controller 708.

An upper column 701 of FIG. 7 indicates a state in which the position of the first sound insulating portion 205a of the sound insulator is appropriate, and a correct pseudo speech signal is output by suppressing the noise signal. The control signal 709 from the sound insulator position controller 708 represents that the sound insulator position is appropriate. The sound insulator position controller 708 instructs the position change mechanism 750 to maintain the current position.

A lower column 702 of FIG. 7 indicates a case in which the occupant 220 has moved downward (y2) or forward (x2) (indicated by 720). In this case, if the first sound insulating portion 205a of the sound insulator is located at the position in the upper column 701, part of the speech uttered by the occupant 720 is shielded by the first sound insulating portion 205a of the sound insulator and does not propagate to the first microphone 201. On the other hand, part of the speech uttered by the occupant 720 is not shielded by the first sound insulating portion 205a of the sound insulator and propagates to the second microphone 203. This state is detected by the sound insulator position controller 708, and the position change mechanism 750 is driven based on the control signal 709 and instructed to move the first sound insulating portion 205a to a position 705. The sound insulator is thus automatically moved to an appropriate position without involvement of the occupant 220.

Note that if the occupant 220 has moved upward or backward, the sound insulator does not inappropriately shield the mixture sounds input to the microphones. However, when the first sound insulating portion of the sound insulator moves downward, the amount of noise mixing into the first microphone 201 increases. Hence, the sound insulator position controller 708 may instruct the position change mechanism 750 to return the first sound insulating portion of the sound insulator to the position in the upper column 701 of FIG. 7 or move the first sound insulating portion upward.

(Processing Procedure of Sound Insulator Position Control)

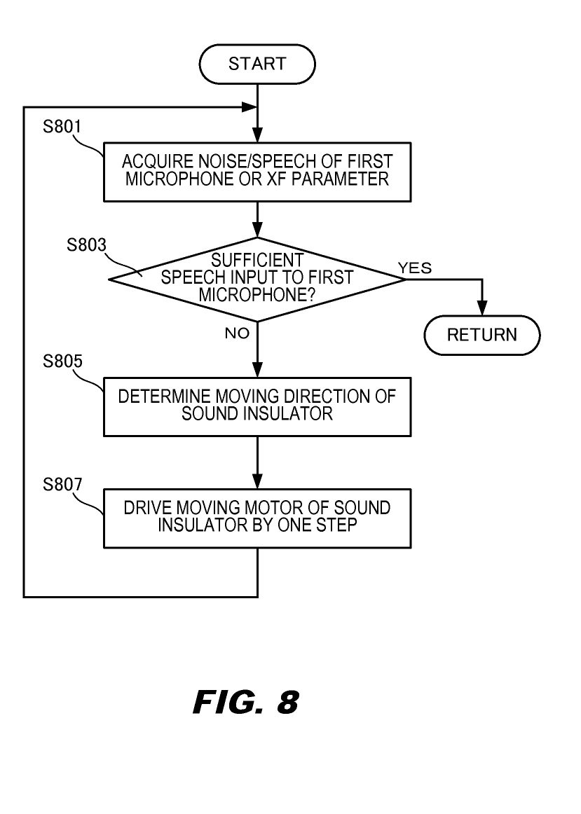

FIG. 8 is a flowchart showing the processing procedure of sound insulator position control according to this embodiment. The CPU 410 shown in FIG. 4A executes the flowchart of FIG. 8 using the RAM 440, thereby implementing the sound insulator position controller 708 shown in FIG. 7.

In step S801, the ratio of noise and speech in the first microphone 201, the parameter of the adaptive filter XF of the circuit shown in FIG. 3, and the like are acquired from the noise suppression circuit 706. In step S803, it is judged whether the speech input to the first microphone 201 is sufficient. If the speech input to the first microphone 201 is sufficient, the processing ends.

On the other hand, if the speech input to the first microphone 201 is not sufficient, the direction to move the sound insulator 205 is determined in step S805. In step S807, the moving motor of the position change mechanism 750 is driven by one step in the determined moving direction. Then, the process returns to step S801 to repeat the processing until the speech is sufficiently input to the first microphone 201.

Note that in the example shown in FIG. 8, the moving motor is driven by one step. However, the sound insulator may be moved to the desired position at once in accordance with the sound insulator/microphone position control parameter DB 451 shown in FIG. 4B.

(First Microphone Position Control)

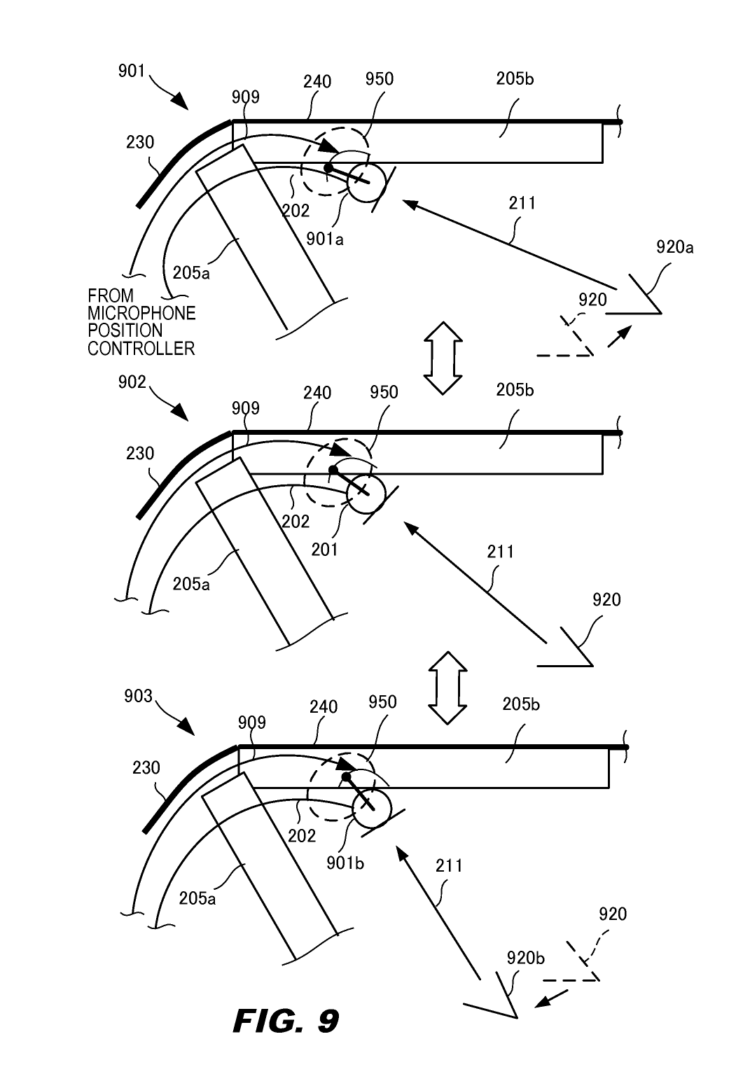

FIG. 9 is a view showing the state of first microphone position control according to this embodiment. In FIG. 9, the apparatus is configured to perform automatic adjustment of the first microphone 201 upon judging that the position (in this example, the direction) of the first microphone 201 is not appropriate. Referring to FIG. 9, a microphone position controller (not shown) and a position change mechanism 950 serving as a microphone moving unit capable of moving the direction of the first microphone 201 in accordance with the control signal of the microphone position controller are added. The position change mechanism 950 can include a moving motor. The apparatus includes a signal line that transmits a control signal 909 of the microphone position controller to the position change mechanism 950. Note that the arrangement for causing the noise suppression circuit to output a parameter for position control to the microphone position controller is the same as in FIG. 7, and an illustration and description thereof will be omitted.

A middle column 902 of FIG. 9 indicates a state in which the position of the first microphone 201 is appropriate for the position of the mouth 920 of the occupant, and a correct pseudo speech signal is output by suppressing the noise signal. The control signal 909 of the signal line from the microphone position controller represents that the first microphone position is appropriate.

An upper column 901 of FIG. 9 indicates a case in which a mouth 920 of the occupant has moved upward or backward (indicated by 920a). In this case, the speech uttered by the mouth 920a of the occupant is not sufficiently input to the first microphone 201 directed as in the middle column 902. The ratio of the speech in the mixture sound lowers, and the correctness of the pseudo speech signal lowers. This state is detected by the microphone position controller, and the position change mechanism 950 is driven based on the control signal 909 to move the first microphone 201 to a position 901a. The first microphone 201 is thus moved to an appropriate sound insulator position.

A lower column 903 of FIG. 9 indicates a case in which the mouth 920 of the occupant has moved downward or forward (indicated by 920b). In this case, the speech uttered by the mouth 920b of the occupant is not sufficiently input to the first microphone 201 directed as in the middle column 902. The ratio of the speech in the mixture sound lowers, and the correctness of the pseudo speech signal lowers. This state is detected by the microphone position controller, and the position change mechanism 950 is driven based on the control signal 909 to move the first microphone 201 to a position 901b. The first microphone 201 is thus moved to an appropriate sound insulator position.

(Processing Procedure of First Microphone Position Control)

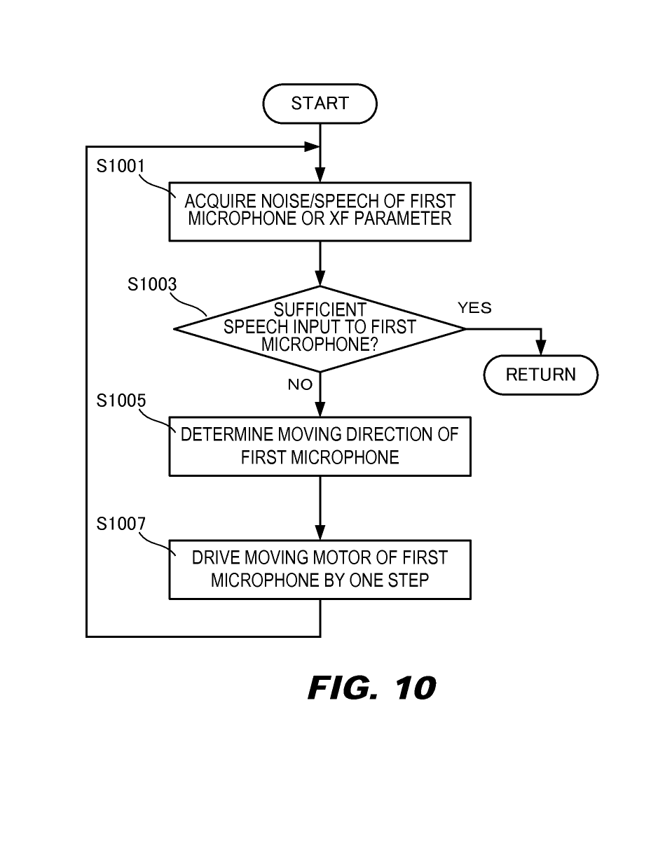

FIG. 10 is a flowchart showing the processing procedure of first microphone position control according to this embodiment. The CPU 410 shown in FIG. 4A executes the flowchart of FIG. 10 using the RAM 440, thereby implementing the microphone position controller (not shown).

In step S1001, the ratio of noise and speech in the first microphone 201, the parameter of the adaptive filter XF of the circuit shown in FIG. 3, and the like are acquired from the noise suppression circuit. In step S1003, it is judged whether the speech input to the first microphone 201 is sufficient. If the speech input to the first microphone 201 is sufficient, the processing ends.

On the other hand, if the speech input to the first microphone 201 is not sufficient, the direction to move the first microphone 201 is determined in step S1005. In step S1007, the moving motor of the position change mechanism 950 is driven by one step in the determined moving direction. Then, the process returns to step S1001 to repeat the processing until the speech is sufficiently input to the first microphone 201.

Note that in the example shown in FIG. 10, the moving motor is driven by one step. However, the first microphone may be moved to the desired position at once in accordance with the sound insulator/microphone position control parameter DB 451 shown in FIG. 4B.

<Other Examples of Sound Insulator of Speech Processing Apparatus>

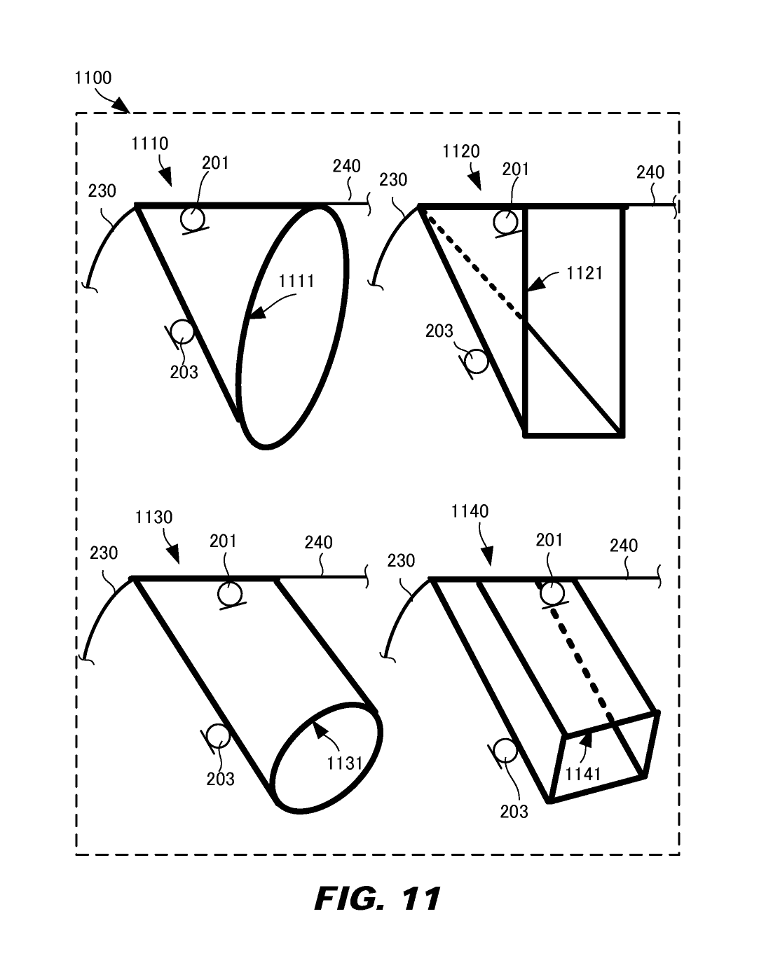

FIG. 11 is a view showing other examples of a sound insulator 1100 of the speech processing apparatus according to this embodiment. FIG. 2 illustrates the first sound insulating portion 205a that is attached to project at a predetermined angle with respect to the ceiling or the windshield and shields input of airborne noise to the first microphone 201, and the second sound insulating portion 205b that is attached to the ceiling and shields input of solid borne noise to the first microphone 201. However, the sound insulator suitably used in this embodiment is not limited to this.

Referring to FIG. 11, reference numeral 1110 denotes a conical sound insulator 1111. The conical sound insulator 1111 has a conical shape having the apex on the side of a line connecting the first microphone 201 and the speech source closer to the first microphone 201, and has the side surface attached to the ceiling 240. The first microphone 201 is attached to the inside of the side surface portion of the conical sound insulator 1111 attached to the ceiling. On the other hand, the second microphone 203 is attached to the outside of the opposite side surface portion of the conical sound insulator 1111 from the first microphone 201.

Referring to FIG. 11, reference numeral 1120 denotes a pyramidal sound insulator 1121. The pyramidal sound insulator 1121 has a pyramidal shape having the apex on the side of a line connecting the first microphone 201 and the speech source closer to the first microphone 201, and has a side surface attached to the ceiling 240. The first microphone 201 is attached to the inside of the side surface portion of the pyramidal sound insulator 1121 attached to the ceiling. On the other hand, the second microphone 203 is attached to the outside of the opposite side surface portion of the pyramidal sound insulator 1121 from the first microphone 201.

Referring to FIG. 11, reference numeral 1130 denotes a cylindrical sound insulator 1131. The cylindrical sound insulator 1131 has a cylindrical shape having the axis in the direction of connecting the first microphone 201 and the speech source. A cylinder is cut at a predetermined angle, and the opening portion is closed by a sound insulator. The lid portion of the sound insulator is attached to the ceiling 240. The first microphone 201 is attached to the inside of the lid portion of the cylindrical sound insulator 1131 attached to the ceiling. On the other hand, the second microphone 203 is attached to the outside of the side surface portion of the cylindrical sound insulator 1131.

Referring to FIG. 11, reference numeral 1140 denotes a rectangular tube insulator 1141. The rectangular tube insulator 1141 has a rectangular tube shape having the axis in the direction of connecting the first microphone 201 and the speech source. A rectangular tube is cut at a predetermined angle, and the opening portion is closed by a sound insulator. The lid portion of the sound insulator is attached to the ceiling 240. The first microphone 201 is attached to the inside of the lid portion of the rectangular tube insulator 1141 attached to the ceiling. On the other hand, the second microphone 203 is attached to the outside of the side surface portion of the rectangular tube insulator 1141.

Note that the structure of the sound insulator is not limited to the above-described examples. The sound insulator preferably has a material, shape, and layout capable of shielding airborne noise and solid borne noise to the first microphone 201 and airborne speech to the second microphone 203. The sound insulator more preferably collects airborne speech to the first microphone 201.

### Third Embodiment

In the second embodiment, an example has been described in which the sound insulator, the first microphone, and the second microphone are attached to the sun visor at the ceiling portion on the front side of the car. In the third embodiment, an example will be described in which the sound insulator, the first microphone, and the second microphone are disposed on the dashboard or under the steering wheel. According this embodiment, it is possible to stably install the components without any instability to vibrations and the like caused by the layout and also prevent noise from mixing due to electromagnetic noise in long signal lines to the control circuit, unlike the second embodiment.

<Arrangement of Speech Processing System Including Speech

Processing Apparatus According to This Embodiment>

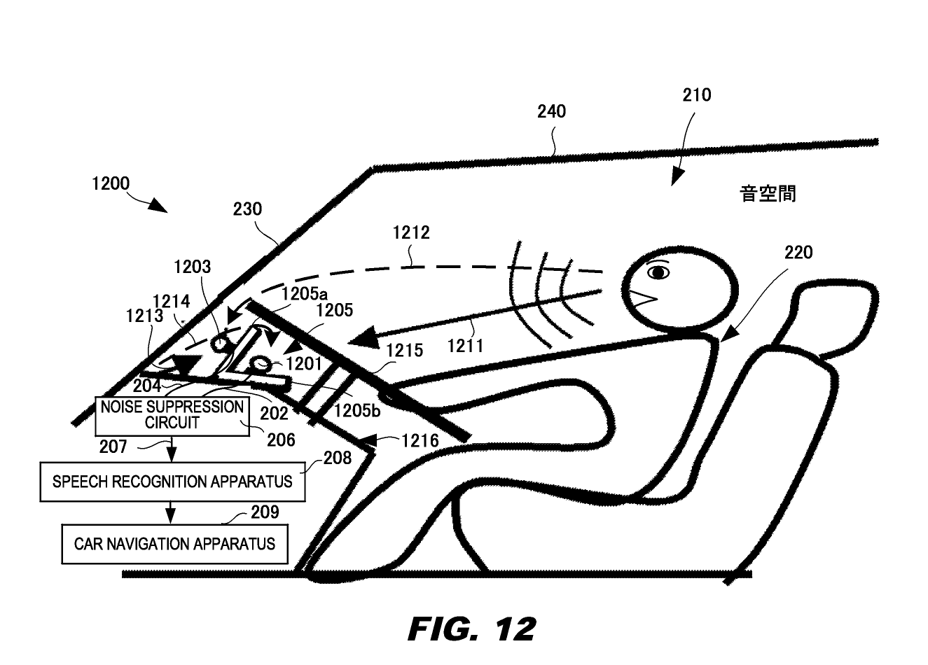

FIG. 12 is a block diagram showing the arrangement of a speech processing system 1200 including a speech processing apparatus according to this embodiment. Note that referring to FIG. 12, the speech processing apparatus includes a first microphone 1201, a second microphone 1203, a sound insulator 1205, and a noise suppression circuit 206. The speech processing system 1200 includes the speech processing apparatus, and additionally, a speech recognition apparatus 208 and a car navigation apparatus 209.

Referring to FIG. 12, a sound space 210 is the space in a vehicle. The sound space 210 shown in FIG. 12 is partially delimited by a windshield 230 and a ceiling 240. The arrangement and operation of this embodiment will be described below by exemplifying a case in which an occupant 220 manipulates the car navigation apparatus 209 by speech in the sound space 210 where noise from an air conditioner or the like mixes. Note that the air conditioner is assumed to exist in a dashboard 1216. However, the noise source is not limited to the air conditioner and may be another device disposed at another position. The speech of the occupant 220 need not always be used to manipulate the car navigation apparatus 209.

In the speech processing apparatus according to this embodiment, the first microphone 1201, the second microphone 1203, and the sound insulator 1205 are disposed on the dashboard 1216 on the front side of the car. The sound insulator 1205 includes a first sound insulating portion 1205a that projects at an acute angle from the dashboard 1216 into the car, and a second sound insulating portion 1205b attached onto the dashboard 1216. The first sound insulating portion 1205a and the second sound insulating portion 1205b forms a “V shape” or an “L shape”. However, the angle of the first sound insulating portion 1205a and the second sound insulating portion 1205b is not limited to the acute angle, and an appropriate angle is selected in accordance with the structure in the vehicle, the structure and position of the dashboard, the seat position, the height of the occupant, the position of the noise source, and the like. Note that the sound insulator 1205 is preferably located at a position on the dashboard 1216 where the sound insulator can collect speech uttered by the occupant 220. The sound insulator 1205 may be installed, for example, behind a steering wheel 1215.

In FIG. 12, the first microphone 1201 is attached to the second sound insulating portion 1205b of the sound insulator 1205 in a direction to input speech uttered by the occupant 220. The second sound insulating portion 1205b of the sound insulator can shield solid borne noise (not shown) transmitted from the air conditioner or the like to the first microphone 1201 through the dashboard 1216. On the other hand, the second microphone 1203 is attached to the opposite surface of the first sound insulating portion 1205a of the sound insulator 1205 from the first microphone 1201 in a direction to input noise generated by the air conditioner inside the dashboard 1216. The first sound insulating portion 1205a of the sound insulator 1205 shields input of airborne noise 1213 from the air conditioner or the like to the first microphone 1201. At the same time, the first sound insulating portion 1205a of the sound insulator 1205 shields input of airborne speech 1211 uttered by the occupant 220 to the second microphone 1203. For this reason, the airborne speech 1211 uttered by the occupant 220 is mainly input to the first microphone 1201, and the airborne noise 1213 generated by the air conditioner is mainly input to the second microphone 1203. However, since the sound insulator 1205 does not form a closed space, airborne noise 1214 getting around the first sound insulating portion 1205a mixes into the first microphone 1201. In addition, airborne speech 1212 getting around the first sound insulating portion 1205a mixes into the second microphone 1203.

The first microphone 1201 converts a first mixture sound including the input airborne speech 1211 and the airborne noise 1214 that has got around into a first mixture signal 202 including a speech signal and a noise signal and transmits it to the noise suppression circuit 206 through a signal line. On the other hand, the second microphone 1203 receives a second mixture sound including the airborne noise 1213 and the airborne speech 1212 that has got around at a ratio different from the first mixture sound. The second microphone 1203 converts the second mixture sound into a second mixture signal 204 including a speech signal and a noise signal at a ratio different from the first mixture signal and transmits it to the noise suppression circuit 206 through a signal line.

The noise suppression circuit 206 outputs a pseudo speech signal 207 based on the transmitted first mixture signal 202 and second mixture signal 204. The pseudo speech signal 207 is recognized by the speech recognition apparatus 208 and processed by the car navigation apparatus 209 as a manipulation by the speech of the occupant 220.

In the above-described way, in the sound space 210 of the vehicle where the desired speech and the in-car noise mix, speech uttered by the occupant 220 and indicating a manipulation of the car navigation apparatus 209 is input to the first microphone 1201 and the second microphone 1203 as mixture sounds of different mixture ratios. The noise suppression circuit 206 reconstructs the pseudo speech signal based on the first mixture signal from the first microphone 1201 and the second mixture signal from the second microphone 1203. The speech recognition apparatus 208 recognizes the reconstructed pseudo speech signal. The car navigation apparatus 209 is manipulated by the recognized speech.

Note that the return signal of a ground power supply or the like or a power supply for operating the microphone may be transmitted using the signal lines that transmit the first mixture signal 202 and the second mixture signal 204. The noise suppression circuit 206 may be attached to the sound insulator 1205. In this case, the pseudo speech signal is transmitted from the noise suppression circuit 206 to the speech recognition apparatus 208 through a signal line. In this embodiment, speech recognition and car navigation will be explained. However, the present invention is not limited to this, and correct reconstruction of the speech uttered by the occupant 220 is useful in another processing as well. For example, application to an automobile telephone or application to a vehicle manipulation that is not directly associated with driving is also possible.

<Arrangement and Operation of Speech Processing Apparatus According to This Embodiment>

As for the arrangement and operation of the speech processing apparatus according to this embodiment, the installation position of the sound insulator 1205, the first microphone 1201, and the second microphone 1203 is changed from the sun visor to the dashboard. However, since the arrangement and processing of the speech processing apparatus remain unchanged, the description of the second embodiment is applied.

### Fourth Embodiment

In the second and third embodiments, the positions of the sound insulator and the first microphone are monitored and controlled using data from the noise suppression circuit. In the fourth embodiment, the sound insulator, the first microphone, and the second microphone are attached to a room mirror. Hence, the direction of the first microphone that mainly inputs speech can uniquely be obtained from the angle of the room mirror. According to this embodiment, it is possible to correctly suppress in-car noise in the sound space in a vehicle where in-car speech and the in-car noise mix by a simple arrangement and processing.

<Arrangement of Speech Processing System Including Speech Processing Apparatus According to This Embodiment>

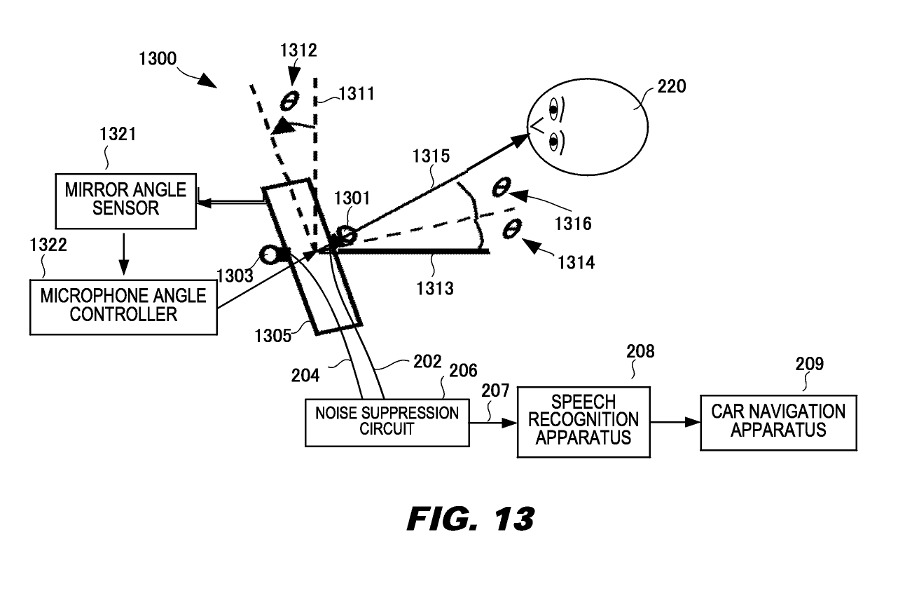

FIG. 13 is a block diagram showing the arrangement of a speech processing system 1300 including a speech processing apparatus according to this embodiment. Note that in FIG. 13, a speech processing apparatus including a sound insulator, a first microphone, and a second microphone attached to a room mirror will be described. In this embodiment, the speech processing apparatus newly includes a mirror angle sensor 1321 and a microphone angle controller 1322. The mirror angle sensor 1321 detects the angle made by the current direction of the room mirror and the direction of the room mirror directed straight toward the rear portion of the vehicle. The microphone angle controller 1322 controls to tilt the first microphone from the normal direction of the room mirror by the same angle as that detected by the mirror angle sensor 1321. The rest of the arrangement is the same as in the second and third embodiments, and a description thereof will be omitted.

A sound insulator 1305 is attached to the room mirror or constitutes the room mirror. A first microphone 1301 is attached to a portion of the mirror surface facing an occupant 220. A second microphone 1303 is attached to the back surface of the room mirror while sandwiching the sound insulator 1305 between it and the first microphone 1301. The sound insulator 1305 of the room mirror can shield input of both airborne noise and solid borne noise to the first microphone 1301.

Note that the first mixture sound input to the first microphone 1301 and the second mixture sound input to the second microphone 1303 are similar to those of the second embodiment, and a description thereof will be omitted. In addition, processing from a noise suppression circuit 206 based on a first mixture signal 202 output from the first microphone 1301 and a second mixture signal 204 output from the second microphone 1303 is the same as in the second and third embodiments, and a description thereof will be omitted.

Referring to FIG. 13, reference numeral 1311 represents a longitudinal direction of the room mirror directed straight toward a rear portion 1313 of the vehicle. Assume that when the room mirror rotates by θ (1312), the occupant 220 can see the rear portion 1313 of the vehicle in front of him/her. In this state, the angle made by the normal direction to the longitudinal direction of the room mirror and the rear portion 1313 of the vehicle is θ (1314) as well, and the mirror angle sensor 1321 detects θ.

Since the image from the rear portion 1313 of the vehicle is reflected by the room mirror and strikes the eye of the occupant 220, the angle made by a direction 1315 from the room mirror to the occupant and the normal direction to the longitudinal direction of the room mirror is θ (1316) as well.

Hence, when the mirror angle sensor 1321 monitors the rotation angle θ (1312) of the room mirror, and the microphone angle controller 1322 moves the direction of the first microphone 1301 by the same angle θ (1316), the first microphone 1301 faces the occupant 220. For this reason, control can be done to input louder speech uttered by the occupant 220.

<Arrangement of Speech Processing Apparatus According to This Embodiment>

As for the arrangement of the speech processing apparatus according to this embodiment, the installation position of the sound insulator 1205, the first microphone 1201, and the second microphone 1203 in the second embodiment is changed to the sound insulator 1305, the first microphone 1301, and the second microphone 1303 of the room mirror. However, since the arrangement of the speech processing apparatus remains unchanged, the description of the second embodiment is applied.

<Processing Procedure of Speech Processing Apparatus According to This Embodiment>

In the processing procedure of the speech processing apparatus according to this embodiment, the sound insulator 1305 cannot freely be moved, unlike the second and third embodiments. Hence, adjustment by moving the sound insulator 1305 is not performed, and controlling the direction of the first microphone 1301 is more important. Position control of the first microphone 1301 according to this embodiment will be described below.

(Processing Procedure of First Microphone Position Control)

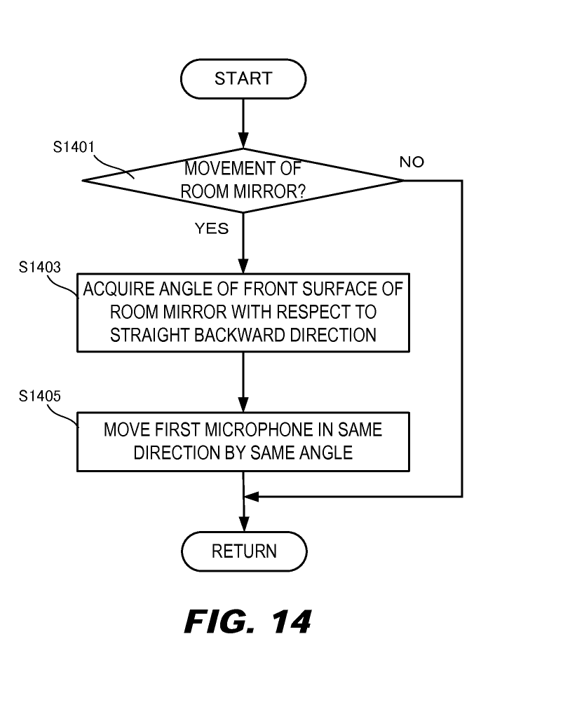

FIG. 14 is a flowchart showing the processing procedure of first microphone position control according to this embodiment. A CPU 410 shown in FIG. 4A executes the flowchart of FIG. 14 using a RAM 440, thereby implementing a microphone position controller (not shown).

In step S1401, it is judged whether movement (especially, a change in the angle) of the room mirror is present. If movement of the room mirror is absent, the processing ends, and the current direction of the first microphone 1301 is maintained.

On the other hand, upon detecting movement of the room mirror, the mirror angle sensor 1321 acquires the angle (θ in FIG. 13) made by the front surface of the room mirror with respect to the straight backward direction in step S1403. In step S1405, the direction of the first microphone 1301 is moved by the same angle as that acquired in step

S1403.

### Fifth Embodiment

In the second to fourth embodiments, an example has been described in which the speech processing apparatus of the present invention is applied to a vehicle. In the fifth embodiment, an example will be described in which the speech processing apparatus of the present invention is applied to a personal computer that is an information processing system. Note that in this embodiment, an example in which the speech processing apparatus is applied to a notebook personal computer (to be referred to as a notebook PC hereinafter) will particularly be explained. However, the present invention is not limited to this. According to this embodiment, it is possible to increase the correctness of reconstruction of speech input in a notebook PC.

<Arrangement of Speech Processing System Including Speech Processing Apparatus According to This Embodiment>

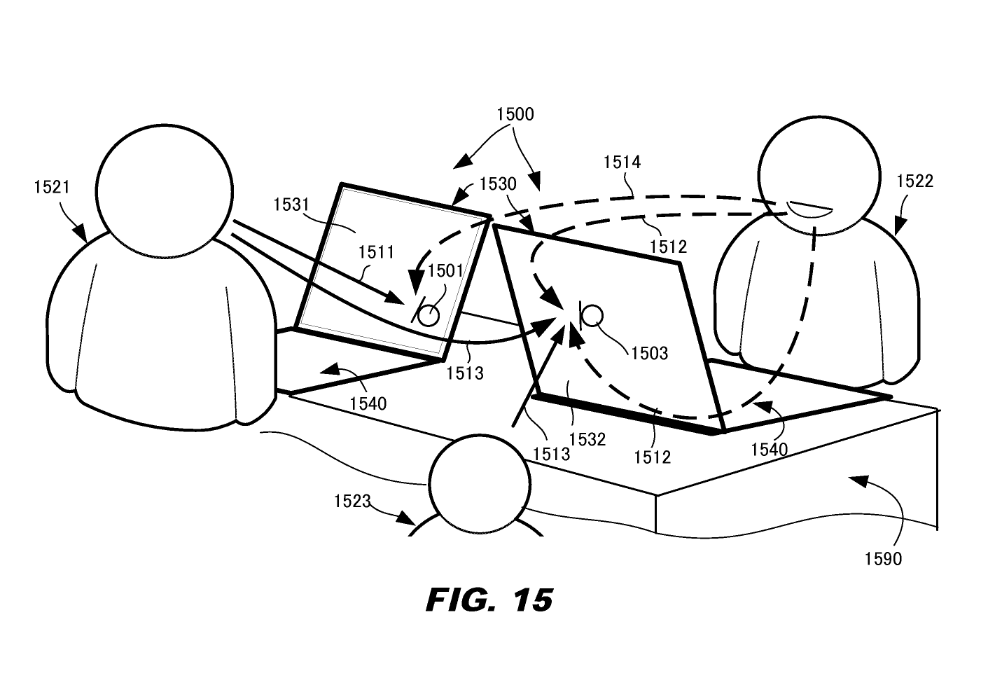

FIG. 15 is a block diagram showing the arrangement of a speech processing system including a speech processing apparatus according to this embodiment.

FIG. 15 illustrates a notebook PC 1500 as a speech processing system. Note that FIG. 15 shows the same notebook PC including a speech processing apparatus from both the front and rear sides. The notebook PC 1500 is formed from a keyboard portion 1540 mainly including a keyboard and a display portion 1530 mainly including a display screen. Sound insulators are attached to the display portion 1530 and the keyboard portion 1540. The sound insulator of the display portion 1530 shields airborne speech and noise. The sound insulator of the keyboard portion 1540 shields solid borne noise from a desk 1590 or the like. Note that the display portion 1530 and the keyboard portion 1540 themselves may be formed as the sound insulators.

The left view of FIG. 15 shows the notebook PC 1500 from the direction of an operator 1521. A first microphone 1501 that mainly inputs speech uttered by the operator 1521 is disposed on a display surface side 1531 of the display portion 1530. The first microphone 1501 receives, as a first mixture sound, speech 1511 uttered by the operator 1521 and noise 1514 uttered by a person 1522 different from the operator 1521 and getting around the display portion 1530. Solid borne noise propagating through the desk 1590 or the like is shielded by the sound insulator of the keyboard portion 1540.

The right view of FIG. 15 shows the notebook PC 1500 from the direction opposite to the operator. A second microphone 1503 that mainly inputs noise is disposed on a back surface (case cover surface) side 1532 of the display portion 1530. The second microphone 1503 receives, as a second mixture sound, speech 1512 uttered by the operator 1522 and getting around the display portion 1530 and noise 1513 uttered by the person 1521 or 1523 other than the operator 1522. Solid borne noise propagating through the desk 1590 or the like is shielded by the sound insulator of the keyboard portion 1540.

(Other Layouts of First Microphone)

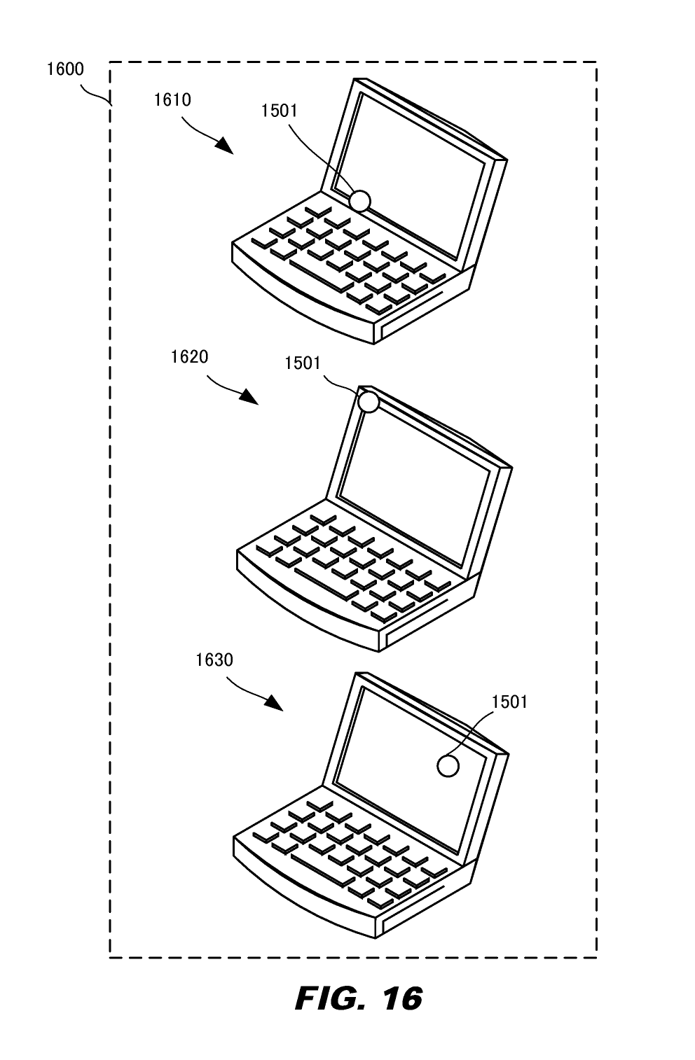

FIG. 16 is a view showing other layouts 1600 of the first microphone according to this embodiment. Note that FIG. 16 shows several examples in which the first microphone 1501 is provided on the display surface of the display portion, as shown in FIG. 15. However, the present invention is not limited to this. The first microphone is preferably located at a position where speech uttered by the operator is input from the front as much as possible, and noise that has got around is shielded by the sound insulator of the display portion as much as possible.

Reference numeral 1610 represents an example in which the first microphone 1501 is disposed near the hinge below the display portion.

Reference numeral 1620 represents an example in which the first microphone 1501 is disposed at the upper portion of the display portion. Reference numeral 1630 represents an example in which the first microphone 1501 is disposed on a side of the display portion.

<Another Arrangement of Speech Processing System Including Speech Processing Apparatus According to This Embodiment>

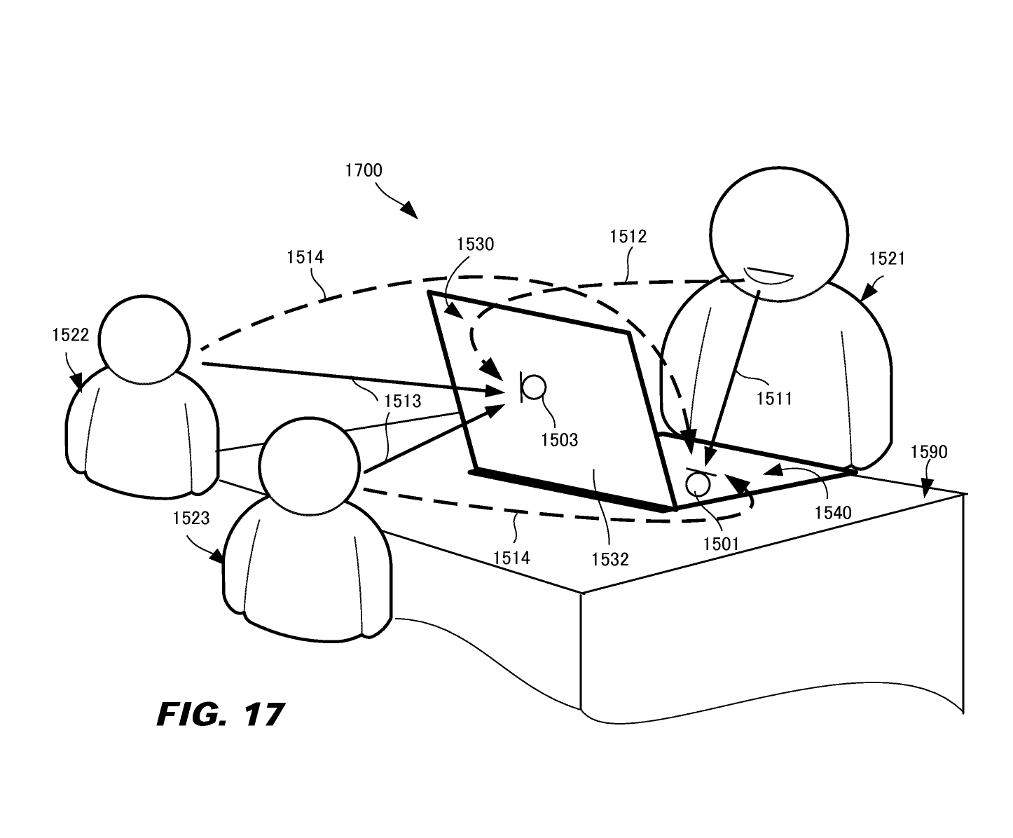

FIG. 17 is a block diagram showing another arrangement of a speech processing system including a speech processing apparatus according to this embodiment.

FIG. 17 illustrates a notebook PC 1700 as a speech processing system. The notebook PC 1700 is formed from the keyboard portion 1540 mainly including a keyboard and the display portion 1530 mainly including a display screen, as in FIG. 15. Sound insulators are attached to the display portion 1530 and the keyboard portion 1540. The sound insulator of the display portion 1530 shields airborne speech and noise. The sound insulator of the keyboard portion 1540 shields solid borne noise from the desk 1590 or the like. Note that the display portion 1530 and the keyboard portion 1540 themselves may be formed as the sound insulators.

Referring to FIG. 17, the first microphone 1501 that mainly inputs speech uttered by the operator 1521 is disposed on the keyboard portion 1540. The first microphone 1501 receives, as the first mixture sound, the speech 1511 uttered by the operator 1521 and the noise 1514 uttered by the person 1522 or 1523 other than the operator 1521 and getting around the display portion 1530. On the other hand, the second microphone 1503 that mainly inputs noise is disposed on the back surface (case cover surface) side 1532 of the display portion 1530. The second microphone 1503 receives, as the second mixture sound, the speech 1512 uttered by the operator 1522 and getting around the display portion 1530 and the noise 1513 uttered by the person 1521 or 1523 other than the operator 1522. Solid borne noise propagating through the desk 1590 or the like is shielded by the sound insulator of the keyboard portion 1540.

(Still Other Layouts of First Microphone)

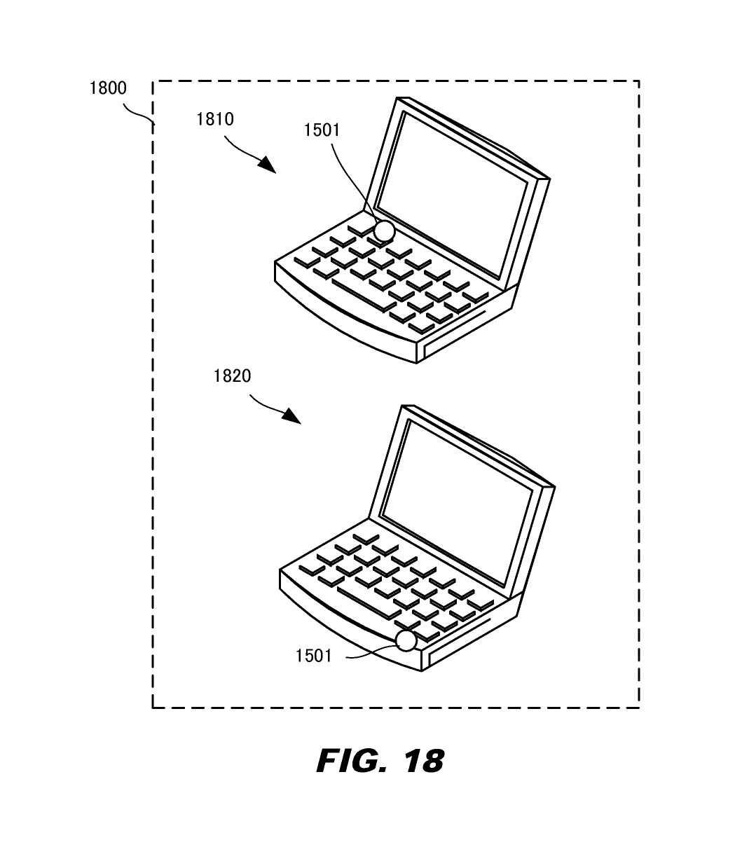

FIG. 18 is a view showing still other layouts 1800 of the first microphone according to this embodiment. Note that FIG. 18 shows several examples in which the first microphone 1501 is provided on the keyboard portion, as shown in FIG. 17. However, the present invention is not limited to this. The first microphone is preferably located at a position where speech uttered by the operator is input from the front as much as possible, and noise that has got around is shielded by the sound insulator of the display portion as much as possible.

Reference numeral 1810 represents an example in which the first microphone 1501 is disposed near the hinge on the far side of the keyboard portion. Reference numeral 1820 represents an example in which the first microphone 1501 is disposed on the near side of the keyboard portion.

<Hardware Arrangement of Speech Processing Apparatus>

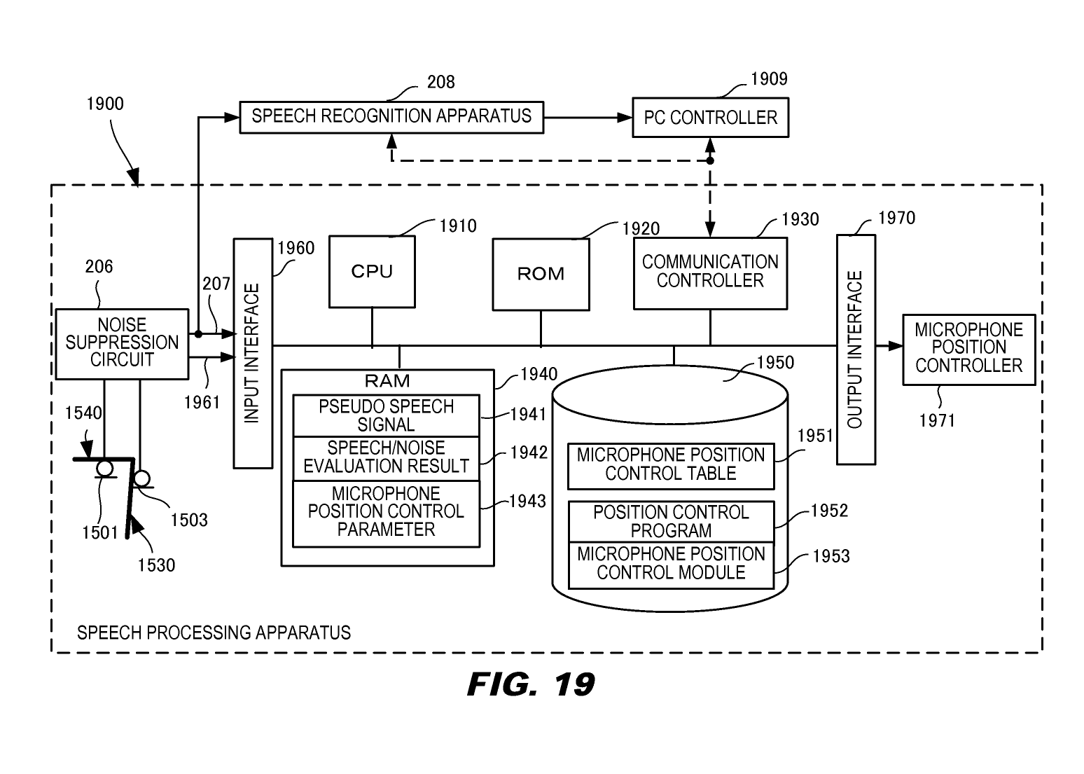

FIG. 19 is a block diagram showing the hardware arrangement of a speech processing apparatus 1900 according to this embodiment. Note that FIG. 19 illustrates a speech recognition apparatus 208 connected to the speech processing apparatus 1900 and a PC controller 1909 that controls information processing in accordance with speech input.

Referring to FIG. 19, a CPU 1910 is a processor for arithmetic control and implements the controller of the speech processing apparatus 1900 by executing a program. A ROM 1920 stores initial data, permanent data of programs and the like, and the programs. A communication controller 1930 exchanges information between the speech processing apparatus 1900, the speech recognition apparatus 208, and the PC controller 1909. The communication can be either wired or wireless. Note that FIG. 19 illustrates a noise suppression circuit 206 as a unique functional component. However, processing of the noise suppression circuit 206 may be implemented partially or wholly by processing of the CPU 1910.

A RAM 1940 is a random access memory used by the CPU 1910 as a work area for temporary storage. Areas to store data necessary for implementing the embodiment are allocated in the RAM 1940. The areas store digital data 1941 of a pseudo speech signal 207 output from the noise suppression circuit 206 and an evaluation result 1942 obtained by evaluating the speech input to the microphone based on the strength of the speech signal, the ratio of the speech and noise, and the like. The RAM 1940 also stores a microphone position control parameter 1943 determined from the evaluation result 1942.

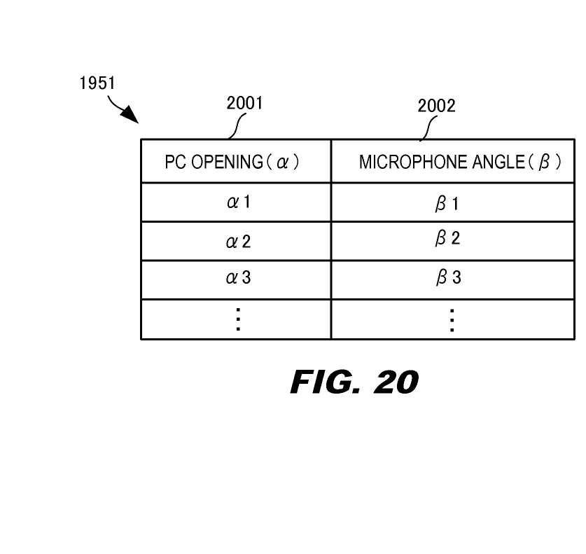

A storage 1950 is a mass storage device that nonvolatilely stores databases, various kinds of parameters, and programs to be executed by the CPU 1910. The storage 1950 stores the following data and programs necessary for implementing the embodiment. As a data storage, the storage 1950 stores a microphone position control table 1951 used to determine the microphone position control parameter 1943 from the evaluation result 1942 (see FIG. 20). In this embodiment, the storage 1950 stores a position control program 1952 used to control the microphone position as a program, and a microphone position control module 1953 that controls the microphone position.

An input interface 1960 inputs control signals and data necessary for control by the CPU 1910. In this embodiment, the input interface 1960 inputs the pseudo speech signal 207 output from the noise suppression circuit 206 and a parameter of an adaptive filter NF 302 or an adaptive filter XF 304 or a parameter 1961 of an estimated noise signal Y1 or the like. The parameter 1961 is used to control the position of the microphone. An output interface 1970 outputs control signals and data to a device under the control of the CPU 1910. In this embodiment, the output interface 1970 outputs the microphone position control parameter 1943 to a microphone position controller 1971. If the microphone position controller 1971 includes a motor, the microphone position control parameter 1943 includes a rotation direction and a rotation angle.

Note that FIG. 19 illustrates only the data and programs indispensable in this embodiment but not general-purpose data and programs such as the OS. The CPU 1910 in FIG. 19 may also perform another PC control.

(Arrangement of Microphone Position Control Table)

FIG. 20 is a view showing the arrangement of the microphone position control table 1951 according to this embodiment.

The microphone position control table 1951 stores an angle (β) representing the direction of the first microphone 1501 in association with the PC opening (α) between the display portion and the keyboard portion of the notebook PC 1700.

Note that instead of providing the microphone position control table, the angle of the first microphone may be obtained by a microphone position control algorithm that calculates the angle of the first microphone from the PC opening.

<Processing Procedure of Speech Processing Apparatus According to This Embodiment>

(First Microphone Position Control)

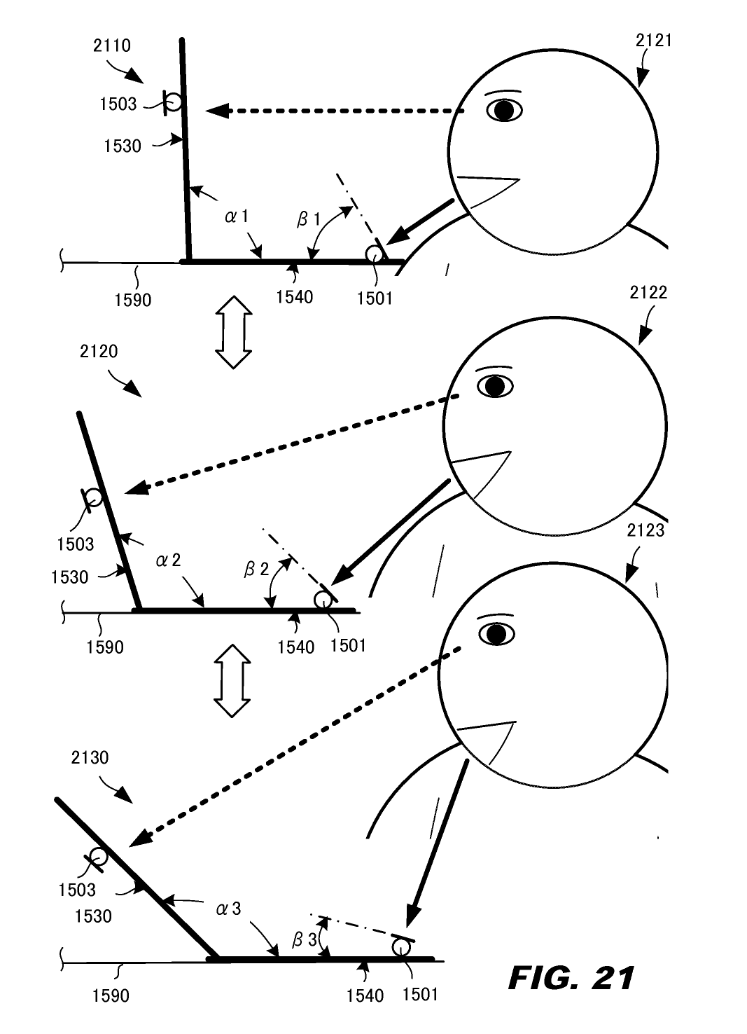

FIG. 21 is a view showing the state of first microphone position control according to this embodiment.

An upper column 2110 of FIG. 21 indicates a case in which the PC opening is α1 and close to 90°. With this PC opening, the face of an operator 2121 is estimated to be at the same level as the screen of the display portion 1530. Hence, an angle β1 of the first microphone 1501 on the keyboard portion 1540 from the keyboard surface is made relatively large, thereby moving the first microphone so as to input speech uttered by the operator 2121 from the front.

A middle column 2120 of FIG. 21 indicates a case in which the PC opening is α2 and close to 120°. With this PC opening, the face of an operator 2122 is estimated to be slightly above the screen of the display portion 1530. Hence, an angle β2 of the first microphone 1501 on the keyboard portion 1540 from the keyboard surface is made smaller than β1, thereby moving the first microphone so as to input speech uttered by the operator 2122 from the front.

A lower column 2130 of FIG. 21 indicates a case in which the PC opening is α3 and close to 135°. With this PC opening, the face of an operator 2123 is estimated to be considerably above the screen of the display portion 1530. Hence, an angle β3 of the first microphone 1501 on the keyboard portion 1540 from the keyboard surface is made smaller than β2, thereby moving the first microphone so as to input speech uttered by the operator 2123 from the front.

(Processing Procedure of First Microphone Position Control)

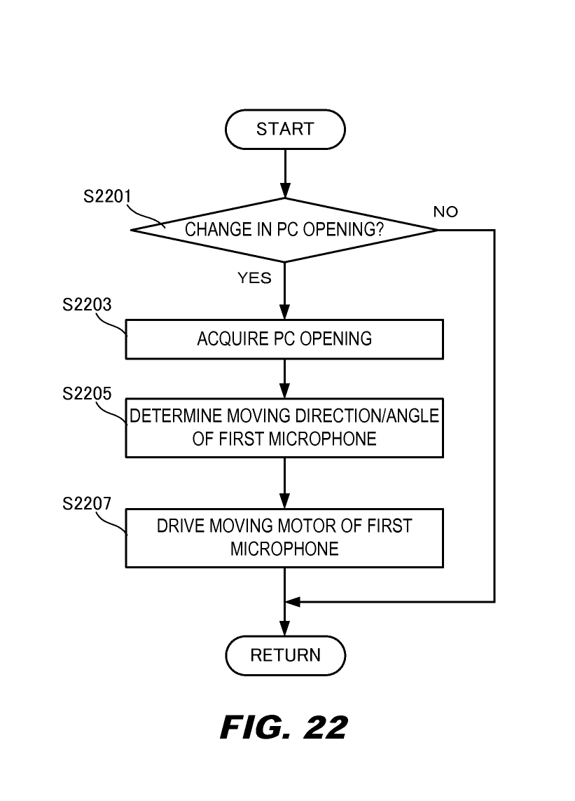

FIG. 22 is a flowchart showing the processing procedure of first microphone position control according to this embodiment. The CPU 1910 shown in FIG. 19 executes the flowchart of FIG. 22 using the RAM 1940, thereby implementing the microphone position controller (not shown).

In step S2201, it is judged whether the PC opening between the display portion 1530 and the keyboard portion 1540 has changed. If the PC opening has not changed, the processing ends, and the current direction of the first microphone 1501 is maintained.

On the other hand, upon detecting a change in the PC opening, the existing detector acquires the PC opening in step S2203. In step S2205, the moving direction and the moving angle of the first microphone 1501 are determined by looking up the microphone position control table 1951 based on the PC opening acquired in step S2203. In step S2207, the moving motor is driven to move the first microphone 1501 by the moving angle in the moving direction determined in step S2205.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. The present invention also incorporates a system or apparatus that somehow combines different features included in the respective embodiments.

The present invention is applicable to a system including a plurality of devices or a single apparatus. The present invention is also applicable even when a control program for implementing the functions of the embodiments is supplied to the system or apparatus directly or from a remote site. Hence, the present invention also incorporates the control program installed in a computer to implement the functions of the present invention on the computer, a medium storing the control program, and a WWW (World Wide Web) server that causes a user to download the control program.

This application claims the benefit of Japanese Patent Application No. 2011-005315 filed on Jan. 13, 2011, which is hereby incorporated by reference herein in its entirety.

1. A speech processing apparatus comprising:
a first microphone that inputs a first mixture sound including desired speech and noise, and outputs a first mixture signal;
a second microphone that is opened to the same sound space as that of said first microphone, inputs a second mixture sound including the desired speech and the noise at a ratio different from the first mixture sound, and outputs a second mixture signal;
a sound insulator that is disposed between said first microphone and said second microphone; and
a noise suppression circuit that suppresses an estimated noise signal based on the first mixture signal and the second mixture signal and outputs a pseudo speech signal.

2. The speech processing apparatus according to claim 1, wherein said sound insulator includes a sound insulating portion that crosses a line segment connecting said first microphone and a source of the noise, and shields an airborne sound of the noise.

3. The speech processing apparatus according to claim 2, wherein said sound insulator further includes a sound insulating portion that shields the noise that gets around from the source of the noise to said first microphone as a solid borne sound.

4. The speech processing apparatus according to claim 1, wherein said sound insulator is disposed such that when said sound insulator is cut along a plane perpendicular to a line connecting said first microphone and a source of the desired speech, a sectional area remains the same or becomes small from the source of the desired speech to said first microphone.

5. The speech processing apparatus according to claim 1, wherein said sound insulator has an L-shaped end face cut along a plane formed by the line connecting said first microphone and the source of the desired speech and the line connecting said first microphone and the source of the noise, and
said first microphone is disposed on an interior angle side of the L-shaped end face, and said second microphone is disposed on an exterior angle side of the L-shaped end face.

6. The speech processing apparatus according to claim 1, wherein said sound insulator has one of a conical shape and a pyramidal shape having an apex on a side of the line connecting said first microphone and the source of the desired speech closer to said first microphone and a cylindrical shape and a rectangular tube shape having an axis in a direction of connecting said first microphone and the source of the desired speech, and
said first microphone is disposed inside said sound insulator, and said second microphone is disposed outside said sound insulator.

7. The speech processing apparatus according to claim 1, further comprising a sound insulator moving unit capable of moving said sound insulator in a direction in which the noise is shielded, and said first microphone collects the desired speech.

8. The speech processing apparatus according to claim 7, further comprising a sound insulator position controller that controls movement of said sound insulator moving unit in accordance with a parameter used by said noise suppression circuit.

9. The speech processing apparatus according to claim 1, further comprising a microphone moving unit capable of moving said first microphone in a direction in which said first microphone collects the desired speech.

10. The speech processing apparatus according to claim 9, further comprising a microphone position controller that controls movement of said microphone moving unit in accordance with a parameter used by said noise suppression circuit.

11. The speech processing apparatus according to claim 1, further comprising an integrated speech input unit including said first microphone, said second microphone, and said sound insulator.

12. The speech processing apparatus according to claim 1, wherein said noise suppression circuit comprises:
a first subtracter that subtracts the estimated noise signal estimated to be included in the first mixture signal from the first mixture signal;
a second subtracter that subtracts an estimated speech signal estimated to be included in the second mixture signal from the second mixture signal;
an estimated noise signal generator that generates the estimated noise signal from an output signal of said second subtracter; and
an estimated speech signal generator that generates the estimated speech signal from an output signal of said first subtracter, and
the pseudo speech signal is the output signal of said first subtracter.

13. A vehicle including a speech processing apparatus of claim 1,
wherein said first microphone is disposed at a position where said sound insulator does not shield desired speech uttered by an occupant but shields noise generated from a noise source, and
said second microphone is disposed at a position where said sound insulator shields the desired speech uttered by the occupant but does not shield the noise generated from the noise source.

14. The vehicle according to claim 13, wherein said sound insulator is attached to a sun visor, and
said first microphone and said second microphone are disposed on both sides of the sun visor.

15. The vehicle according to claim 14, wherein said sound insulator is further attached to a ceiling, and
said first microphone is attached to said sound insulator attached to the ceiling.

16. The vehicle according to claim 13, wherein said first microphone, said second microphone, and said sound insulator are disposed on an upper portion of a dashboard or under a steering wheel.

17. The vehicle according to claim 16, wherein a part of said sound insulator is attached to the upper portion of the dashboard, and another part of said sound insulator extends in a direction to separate from the upper portion of the dashboard,
said first microphone is attached to the upper portion of the dashboard and attached to the part of said sound insulator, and
said second microphone is disposed at a position to sandwich, with said first microphone, the other part of said sound insulator extending in the direction to separate from the upper portion of the dashboard.

18. The vehicle according to claim 13, wherein said sound insulator is attached to a room minor, and
said first microphone and said second microphone are disposed on both sides of the room minor.

19. An information processing apparatus including a speech processing apparatus of claim 1,
wherein said first microphone is disposed at a position where said sound insulator does not shield desired speech uttered by an operator of the information processing apparatus but shields noise generated from a noise source, and
said second microphone is disposed at a position where said sound insulator shields the desired speech uttered by the operator but does not shield the noise generated from the noise source.

20. The information processing apparatus according to claim 19, wherein said sound insulator is attached to a display, and
said first microphone and said second microphone are disposed on both sides of the display.

21. The information processing apparatus according to claim 19, wherein the information processing apparatus comprises a notebook personal computer,
said first microphone is disposed on a display surface side of the display, and said second microphone is disposed on a surface of the display opposite to the operator.

22. The information processing apparatus according to claim 20, wherein said sound insulator is further attached to a keyboard surface, and
said first microphone is disposed on the keyboard surface.

23. The information processing apparatus according to claim 19, wherein the information processing apparatus comprises a notebook personal computer, and
the information processing apparatus further comprises a microphone moving unit capable of moving said first microphone in a direction in which said first microphone collects the desired speech.

24. The information processing apparatus according to claim 23, further comprising a microphone position controller that controls movement of said microphone moving unit in accordance with an angle made by a display surface of the display and the keyboard surface.

25. An information processing system including a speech processing apparatus of claim 1, comprising:
a speech recognition apparatus that recognizes desired speech from the pseudo speech signal output from the speech processing apparatus; and
an information processing apparatus that processes information in accordance with the desired speech recognized by said speech recognition apparatus.

26. A control method of a speech processing apparatus including:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a sound insulator that is disposed between the first microphone and the second microphone; and
a noise suppression circuit that suppresses an estimated noise signal based on the first mixture signal and the second mixture signal and outputs a pseudo speech signal, the method comprising:
acquiring a parameter of the noise suppression circuit;
determining, in accordance with the parameter of the noise suppression circuit, at least one of a position of the sound insulator and a direction of the first microphone to shield the noise and cause the first microphone to collect the desired speech; and
controlling at least one of the position of the sound insulator and the direction of the first microphone.

27. A non-transitory computer-readable storage medium storing a control program of a speech processing apparatus including:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a sound insulator that is disposed between the first microphone and the second microphone; and
a noise suppression circuit that suppresses an estimated noise signal based on the first mixture signal and the second mixture signal and outputs a pseudo speech signal, the control program causing a computer to execute:
acquiring a parameter of the noise suppression circuit;
determining, in accordance with the parameter of the noise suppression circuit, at least one of a position of the sound insulator and a direction of the first microphone to shield the noise and cause the first microphone to collect the desired speech; and
controlling at least one of the position of the sound insulator and the direction of the first microphone.
